(19) United States
(12) Patent Application Publication
(10) Pub. No.: US 2024/0399739 A1
(43) Pub. Date: Dec. 5, 2024

(54) IMAGE FORMING APPARATUS, INFORMATION PROCESSING METHOD, AND STORAGE MEDIUM

(71) Applicant: CANON KABUSHIKI KAISHA, Tokyo (JP)

(72) Inventors: YUTA IKESHIMA, Kanagawa (JP); KAZUKI NARUMI, Tokyo (JP); TORU OHNISHI, Kanagawa (JP); TOMOKAZU ISHIKAWA, Kanagawa (JP); FUMITAKA GOTO, Tokyo (JP); TAKAHISA AKAISHI, Kanagawa (JP); YOHEI KOHASHI, Kanagawa (JP); YUTARO NAKATSUKA, Tokyo (JP); YOICHI TAKADA, Kanagawa (JP); KENJI SHINJO, Kanagawa (JP)

(21) Appl. No.: 18/675,889

(22) Filed: May 28, 2024

(30) Foreign Application Priority Data
May 29, 2023 (JP) 2023-088068
Jun. 16, 2023 (JP) 2023-099544
Feb. 26, 2024 (JP) 2024-026908

(51) Int. Cl. B41J 2/045; B41J 2/15; B41J 2/175; B41J 2/21

(52) U.S. Cl. CPC B41J 2/04535; B41J 2/04573; B41J 2/15; B41J 2/2114; B41J 2002/17569

(57) ABSTRACT

There is provided with an image forming apparatus. A deciding unit decides a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus. A controlling unit controls discharge of the reaction liquid and the inks of the not less than two colors.

### BACKGROUND OF THE INVENTION

### Field of the Invention

The present invention relates to an image forming apparatus, an information processing method, and a storage medium.

### Description of the Related Art

As a method of forming an image on a print medium, there is conventionally known an inkjet type image forming apparatus that forms an image on a print medium by jetting aqueous ink containing a color material from printing elements. A method is appearing, which, when performing such image formation, jets a reaction liquid together with ink, brings these into contact with each other to cause reaction on a print medium, thereby fixing a color material on the print medium.

In such a method, to efficiently fix the ink, an appropriate amount of reaction liquid needs to be used. Japanese Patent Laid-Open No. 2002-321349 discloses a technique of obtaining a proper amount of treatment liquid by changing, in accordance with a type of ink, the discharge amount of a treatment liquid that is a reaction liquid.

### SUMMARY OF THE INVENTION

According to one embodiment of the present invention, an image forming apparatus comprises: a deciding unit configured to decide a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and a controlling unit configured to control discharge of the reaction liquid and the inks of the not less than two colors.

According to another embodiment of the present invention, an image forming apparatus comprises: a controlling unit configured to control discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged; a classifying unit configured to classify the print medium into a print medium that a liquid readily permeates and a print medium that a liquid hardly permeates; and a setting unit configured to set a discharge amount of the reaction liquid corresponding to a discharge amount of one of the first ink and the second ink, wherein the setting unit sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

According to yet another embodiment of the present invention, an image forming apparatus comprises: a setting unit configured to set a weight coefficient on an ink type basis for each of a reaction liquid discharged onto a print medium by the image forming apparatus and an ink discharged onto the print medium next to the reaction liquid; and a deciding unit configured to decide, based on the weight coefficient and a discharge amount of the ink by the image forming apparatus, a discharge amount of the reaction liquid discharged before the ink.

According to still another embodiment of the present invention, an information processing method comprises: deciding a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and controlling discharge of the reaction liquid and the inks of the not less than two colors.

According to yet still another embodiment of the present invention, an information processing method comprises: controlling discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged; classifying the print medium into a print medium that a liquid readily permeates and a print medium that a liquid hardly permeates; and setting a discharge amount of the reaction liquid corresponding to a discharge amount of one of the first ink and the second ink, wherein the setting sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

According to still yet another embodiment of the present invention, an information processing method comprises: setting a weight coefficient on an ink type basis for each of a reaction liquid discharged onto a print medium by the image forming apparatus and an ink discharged onto the print medium next to the reaction liquid; and deciding, based on the weight coefficient and a discharge amount of the ink by the image forming apparatus, a discharge amount of the reaction liquid discharged before the ink.

According to yet still another embodiment of the present invention, a non-transitory computer-readable storage medium stores a program that, when executed by a computer, causes the computer to perform an information processing method, the information processing method comprising: deciding a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and controlling discharge of the reaction liquid and the inks of the not less than two colors.

According to still yet another embodiment of the present invention, a non-transitory computer-readable storage medium stores a program that, when executed by a computer, causes the computer to perform an information processing method, the information processing method comprising: controlling discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged; classifying the print medium into a print medium that a liquid readily permeates and a print medium that a liquid hardly permeates; and setting a discharge amount of the reaction liquid corresponding to a discharge amount of one of the first ink and the second ink, wherein the setting sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

According to yet still another embodiment of the present invention, a non-transitory computer-readable storage medium stores a program that, when executed by a computer, causes the computer to perform an information processing method, the information processing method comprising: setting a weight coefficient on an ink type basis for each of a reaction liquid discharged onto a print medium by the image forming apparatus and an ink discharged onto the print medium next to the reaction liquid; and deciding, based on the weight coefficient and a discharge amount of the ink by the image forming apparatus, a discharge amount of the reaction liquid discharged before the ink.

Further features of the present invention will become apparent from the following description of exemplary embodiments (with reference to the attached drawings).

### BRIEF DESCRIPTION OF THE DRAWINGS

FIG. 1 is a view showing an example of the configuration of an image forming apparatus according to the first embodiment;

FIG. 2 is a view showing an example of the configuration of a printhead according to the first embodiment;

FIG. 3 is a block diagram showing an example of the configuration of a system according to the first embodiment;

FIG. 4 is a flowchart showing an example of image processing according to the first embodiment;

FIG. 5 is a flowchart showing an example of image formation processing according to the first embodiment;

FIG. 6 is a view for explaining the distance from discharge of a reaction liquid to discharge of each ink;

FIGS. 7A, 7B, and 7C are views for explaining the decrease amount of the reaction liquid according to the distance from discharge of the reaction liquid;

FIG. 8 is a view for explaining the reaction liquid to be compensated for using a weight coefficient;

FIG. 9 is a view showing an LUT for reaction liquid amount decision according to the second embodiment;

FIG. 10 is a view for explaining reaction liquid amount decision according to the second embodiment;

FIG. 11 is a view for explaining another example of reaction liquid amount decision according to the second embodiment;

FIG. 12 is a flowchart showing another example of image processing according to the second embodiment;

FIG. 13 is a flowchart showing still another example of image processing according to the second embodiment;

FIG. 14 is a view showing another example of an LUT for reaction liquid amount decision according to the second embodiment;

FIG. 15 is a view showing still another example of the LUT for reaction liquid amount decision according to the second embodiment;

FIGS. 16A, 16B, and 16C are views for explaining reaction aggregation of a reaction liquid and a color ink according to the third embodiment;

FIG. 17 is a view for explaining reaction liquid amount decision processing according to the third embodiment;

FIGS. 18A, 18B, and 18C are views for explaining reaction liquid amount decision processing according to the fourth embodiment;

FIG. 19 is a schematic view showing an example of an image forming apparatus according to the fifth embodiment;

FIGS. 20A, 20B, and 20C are views for explaining the discharge time difference between a reaction liquid and ink according to the fifth embodiment; and

FIGS. 21A, 21B, and 21C are views for explaining the discharge time difference between a reaction liquid and ink according to the fifth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

After landing of a reaction liquid on a print medium, the reaction liquid amount on the print medium surface decreases over time due to absorption into the print medium or evaporation. If the reaction liquid is imparted to a medium that a liquid readily permeates, the reaction liquid amount remaining on the sheet surface decreases depending on the time elapsed after the imparting of the reaction liquid. In particular, if a plurality of inks are sequentially imparted after the imparting of the reaction liquid, the reaction liquid amount remaining on the sheet surface changes between the first timing of imparting an ink and the next timing of imparting an ink. In Japanese Patent Laid-Open No. 2002-321349, the reaction liquid amount decrease by the elapse of time is not taken into consideration, and even if a proper reaction liquid amount is set for each ink, no appropriate reaction liquid amount can be obtained at the time of landing of an ink.

Even if paper that a liquid hardly permeates is used, if aggregability with a reaction liquid changes on an ink basis, the necessary reaction liquid amount changes in accordance with the aggregability. Japanese Patent Laid-Open No. 2002-321349 mentions that the necessary reaction liquid amount changes depending on the difference of color material density or the color material type. On the other hand, since the aggregability between the reaction liquid and the ink changes also depending on components other than the color material, in the technique described in Japanese Patent Laid-Open No. 2002-321349, an appropriate reaction liquid amount cannot be decided only based on the aggregability between the color material and the reaction liquid.

The appropriate reaction liquid amount cannot be defined for each ink due to the above-described factors. If the amount of the reaction liquid is short, ink fixing is insufficient, resulting in harmful effects in image formation, such as density lowering, image unevenness, and image deletion.

The embodiments of the present invention provide an image forming apparatus that appropriately sets the amount of a reaction liquid for ink and suppresses image unevenness.

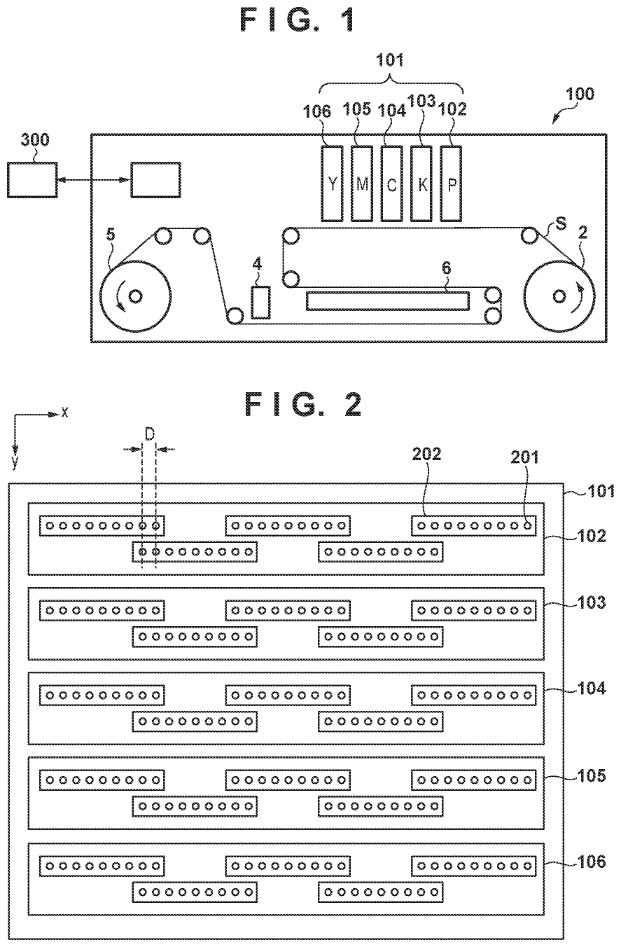

In the apparatus shown in FIG. 1, the upper side of the apparatus is defined as “above”, the direction from right to left is defined as “longitudinal direction”, and the direction from the near side of a sheet to the far side, which is orthogonal to the print medium conveyance direction, is defined as “sheet width direction”. Also, an image forming apparatus 100 to be described below is assumed to be a high-speed line printer that uses a continuous sheet wound in a roll as a print medium.

### First Embodiment

### [Image Forming Apparatus]

FIG. 1 is a schematic view of an inkjet printing apparatus (to be referred to as an image forming apparatus hereinafter) controlled by an information processing apparatus according to this embodiment and forms an image. The image forming apparatus 100 according to this embodiment includes an unwinding roll unit 2, a printing unit 101, a scanner unit 4, a winding roll unit 5, and a drying unit 6. A sheet S that is a print medium is conveyed along a sheet conveyance path indicated by a solid line in FIG. 1, and undergoes processing in each unit. The image forming apparatus 100 according to this embodiment performs the process of image formation along the sheet conveyance direction (sheet S).

The unwinding roll unit 2 is a unit configured to hold and supply a continuous sheet wound in a roll. The unwinding roll unit 2 is configured to store an unwinding roll and pull out and supply the sheet S. Note that the number of rolls that can be stored is not limited to one, and two or three or more rolls may be stored, and the sheet S may selectively pulled out and supplied.

The image forming apparatus 100 according to this embodiment is a full line type image forming apparatus, and forms an image by the printing unit 101 having a width equal to or more than the width of the print medium. The following description will be made assuming that processing of discharging a reaction liquid (P) onto the print medium and, after that, sequentially discharging color inks of black (K), cyan (C), magenta (M), and yellow (Y) is performed in image formation processing according to this embodiment. However, color inks different from these may be used. For example, as the ink, light cyan ink or light magenta ink may be used for the purpose of improving graininess, or red ink, green ink, or blue ink may be used for the purpose of improving color development. Also, clear (transparent) ink may be used as the ink.

The printing unit 101 includes printheads 102 to 106, and the printheads sequentially discharge the reaction liquid (P), and the color inks of black (K), cyan (C), magenta (M), and yellow (Y), respectively. The printhead 102 discharges the reaction liquid, and the printheads 103 to 106 discharge the inks of black (K), cyan (C), magenta (M), and yellow (Y), respectively. The printheads 102 to 106 are juxtaposed in this order in the conveyance direction (y direction) of the print medium. The reaction liquid and the color inks are discharged by the printheads 102 to 106, thereby imparting the reaction liquid and the inks to the print medium and forming an image.

The reaction liquid according to this embodiment is a liquid containing a component that increases the viscosity of ink. Here, increasing the ink viscosity is a state in which a color material or a resin of ink contacts the component that increases the viscosity of the ink and causes a chemical reaction or physical adsorption, thereby exhibiting rise of the ink viscosity.

If the reaction liquid is imparted before ink imparting onto the sheet S, the ink that has reached the sheet S can be fixed. This can suppress beading caused by mixing of adjacent inks.

In image formation processing according to this embodiment, the print medium is conveyed at a predetermined speed in the longitudinal direction in FIG. 1 along with rotation of the unwinding roll unit 2 and the winding roll unit 5, and during this conveyance, image formation processing by the printing unit 101 is performed. The print medium at the position where the image formation processing by the printing unit 101 is performed maintains smoothness and the distance from the printing unit 101 during image formation.

In the image formation processing according to this embodiment, after the reaction liquid is formed on the print medium by the printhead 102, the printheads 103 to 106 form color inks on the print medium such that these partially overlap the formation region of the reaction liquid. The reaction liquid according to this embodiment contacts each color ink on the print medium, thereby aggregating the color material of the color ink and holding it in the place. For example, in a case where image formation is performed on an absorption type print medium that internally absorbs a liquid, the color material can be held in an upper layer of the print medium by using the reaction liquid. In a case where image formation is performed on a non-absorption type print medium that keeps a liquid on the surface layer, if the reaction liquid is used, the color material stays at a portion of the print medium surface where a reaction occurs. When image formation processing is performed using the reaction liquid, the density of a formed image can be increased, and occurrence of harmful effects in image formation, such as image unevenness and image deletion, can be suppressed.

### [Printing Unit]

FIG. 2 is a schematic view of the printing unit 101 used in the image forming apparatus 100 according to this embodiment. In each of the printheads 102 to 106 corresponding to the ink color, a plurality of printing element arrays 202 are alternately arranged in the y direction such that these continue in the x direction with overlap regions D provided. Each printing element array 202 includes a plurality of printing elements 201 arrayed at a predetermined pitch. In accordance with print data, the printing elements 201 discharge ink at a predetermined frequency to the print medium that is conveyed in the y direction at a predetermined speed, thereby forming, on the print medium, an image having a resolution according to the array pitch of the printing elements 201. Here, “print data” is data representing various kinds of processing to be performed by the image forming apparatus, including image data used in image formation.

### [Preparation of Reaction Liquid]

The reaction liquid used in this embodiment contains a reactive component that reacts with a pigment contained in ink and aggregates or gelatinizes the pigment. The reactive component, more specifically, an ink containing a pigment that is stably dispersed in an aqueous medium by the action of an ionic group or a component capable of destroying the dispersion stability of ink when mixed on a print medium or the like. More specifically, in this embodiment, magnesium sulfate is used as the reaction liquid. However, the reaction liquid is not always limited to this. In this embodiment, for example, various organic acids or cationic components such as multivalent metal salts/cationic resins may be used as the reactive component of the reaction liquid if these are water-soluble.

Examples of multivalent metal ions are divalent metal ions such as Ca²⁺, Cu²⁺, Ni²⁺, Mg²⁺, Sr²⁺, Ba²⁺, and Zn²⁺, and trivalent metal ions such as Fe³⁺, Cr³⁺, Y³⁺, and Al³⁺. To cause the reaction liquid to contain multivalent metal ions, a multivalent metal salt (or a hydrate is also possible) formed by bonding a multivalent metal ion to an anion can be used. Examples of the anion are inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻, and organic anions such as HCOO⁻, (COO⁻)₂, COOH(COO⁻), CH₃COO⁻, C₂H₄(COO⁻)₂, C₆H₅COO⁻, C₆H₄(COO⁻)₂, and CH₃SO₃⁻. If multivalent metal ions are used as a reactant, the content (mass %) in the reaction liquid expressed in terms of the multivalent metal salt is preferably 1.0 mass % (inclusive) to 20.0 mass % (inclusive) with respect to the total mass of the reaction liquid as a reference.

A reaction liquid containing an organic acid has a buffer capacity in an acidic region (less than pH 7.0, preferably pH 2.0 to 5.0), thereby efficiently making an anionic group, which is a component existing in ink, acidic and aggregating. Examples of the organic acid are monocarboxylic acids such as formic acid, acetic acid, propionic acid, butyric acid, benzoic acid, glycolic acid, lactic acid, salicylic acid, pyrrole carboxylic acid, furane carboxylic acid, picolinic acid, nicotinic acid, thiophene carboxylic acid, levulinic acid, and coumalic acid, and salts thereof, dicarboxylic acids such as oxalic acid, malonic acid, succinic acid, glutaric acid, adipic acid, maleic acid, fumaric acid, itaconic acid, sebacic acid, phthalic acid, malic acid, and tartaric acid, and salts or hydrogen salts thereof, tricarboxylic acids such as citric acid and trimellitic acid, and salts or hydrogen salts thereof, and tetracarboxylic acids such as pyromellitic acid, and salts or hydrogen salts thereof. The content (mass %) of the organic acid in the reaction liquid is preferably 1.0 mass % (inclusive) to 50.0 mass % (inclusive) with respect to the total mass of the reaction liquid as a reference.

Examples of the cationic resin are resins having a structure of primary to tertiary amines and resins having a structure of quaternary ammonium salt. More specifically, examples of the cationic resin are resins having a structure of vinylamine, allylamine, vinylimidazole, vinylpyridine, dimethylaminoethyl methacrylate, ethyleneimine, or guanidine. To improve solubility in the reaction liquid, a cationic resin and an acidic compound may be used together, and quaternization treatment may be performed for the cationic resin. If a cationic resin is used as the reactant, the content (mass %) of the cationic resin in the reaction liquid is preferably 1.0 mass % (inclusive) to 10.0 mass % (inclusive) with respect to the total mass of the reaction liquid as a reference.

### [Making of Ink]

In this embodiment, magnesium sulfate (available from FUJIFILM Wako Pure Chemical Corporation) was used as a reaction liquid, and the reaction liquid was made by mixing the following components.
magnesium sulfate heptahydrate: 15.0 parts
1,2-propanediol: 15.0 parts
acetylenol E100: 0.3 parts
ion-exchanged water: balance

### [Composition of Ink]

Ink formulation in this embodiment will be described next in detail. The present invention is not limited by the following embodiments unless it departs from the scope thereof. Note that “parts” and “%” in the text are on a mass basis unless otherwise specified.

### [Making of Resin Microparticle Dispersion]

Ink according to the first embodiment contains water-soluble resin microparticles in order to bring the print medium and the color material into tight contact with each other and improve the scratch resistance (fixation) of a printed image. The resin microparticles melt with heat, and film formation of the resin microparticles and drying of a solvent contained in the ink are performed by a heater. In the present invention, “resin microparticles” mean polymer microparticles that exist in a state in which they are dispersed in water. In this embodiment, examples of resin microparticles are acrylic resin microparticles synthesized by emulsion polymerization of a monomer such as alkyl ester (meth)acrylate or alkyl amide (meth)acrylate, styrene-acrylic resin microparticles synthesized by emulsion polymerization of monomers such as alkyl ester (meth)acrylate or alkyl amide (meth)acrylate and styrene, polyethylene resin microparticles, polypropylene resin microparticles, polyurethane resin microparticles, and styrene-butadiene resin microparticles. It is also possible to use core-shell resin microparticles in which a core portion and a shell portion forming the resin microparticle have different polymer compositions, and resin microparticles obtained by performing emulsion polymerization around acryl-based microparticles, as seed particles, previously synthesized in order to control the particle size. Furthermore, it is possible to use hybrid resin microparticles obtained by chemically bonding different resin microparticles such as acrylic resin microparticles and urethane resin microparticles.

Also, “polymer microparticles that exist in a state in which they are dispersed in water” can be a form of resin microparticles obtained by homopolymerization of a monomer having a dissociable group or copolymerization of a plurality of types, that is, a so-called self-dispersing resin microparticle dispersion. Examples of the dissociable group are a carboxyl group, a sulfonic acid group, and a phosphoric acid group, and examples of a monomer having this dissociable group are acrylic acid and methacrylic acid. Also, a so-called emulsion-dispersing resin microparticle dispersion obtained by dispersing resin microparticles using an emulsifier may be used as the polymer microparticles. As an emulsifier, it is possible to use a material having anionic electric charge regardless of whether the molecular weight is low or high.

In a four-neck flask including a stirrer, a reflux condenser, and a nitrogen gas introduction pipe, 74.0 parts of ion-exchanged water and 0.2 parts of potassium persulfate were put and mixed. In addition, 24.0 parts of ethyl methacrylate, 1.5 parts of methacrylic acid, and 0.3 parts of a reactive surfactant (product name “AQUALON KH-05” available from DKS) were mixed to prepare an emulsion. Under a nitrogen atmosphere, the prepared emulsion was dripped into the above-described four-neck flask for 1 hr, and polymerization was performed for 2 hrs while stirring at 80° C. After cooling to 25° C., ion-exchanged water and an aqueous solution containing potassium hydroxide equimolar with the acid value of resin particles were added, and an aqueous dispersion of resin particles in which the content of resin particles (solid matter) was 25.0% was prepared. A method of preparing each ink will be described below.

### [Preparation of Pigment Dispersion]

### (Pigment Dispersion 1)

A styrene-ethyl acrylate-acrylic acid copolymer (resin 1) having an acid value of 150 mgKOH/g and a weight-average molecular weight of 8,000 was prepared. After 20.0 parts of resin 1 were neutralized by potassium hydroxide equimolar with its acid value, an appropriate amount of pure water was added, thereby preparing an aqueous solution of resin 1 in which the content of the resin (solid matter) was 20.0%, 10.0 parts of a pigment (carbon black), 15.0 parts of the aqueous solution of resin 1, and 75.0 parts of pure water were mixed, thereby obtaining a mixture. The obtained mixture and 200 parts of zirconia beads with a diameter of 0.3 mm were put in a batch type vertical sand mill (available from IMEX) and dispersed for 5 hrs while water-cooling. After coarse particles were removed by centrifuging, the mixture was filtered under pressure using a cellulose acetate filter with a pore size of 3.0 μm (available from ADVANTEC), thereby preparing pigment dispersion 1 in which the content of the pigment was 10.0%, and the content of the resin dispersant (resin 1) was 3.0%.

### (Pigment Dispersion 2)

Pigment dispersion 2 in which the content of the pigment was 10.0%, and the content of the resin dispersant (resin 1) was 3.0% was prepared in accordance with the same procedure as the above-described pigment dispersion 1 except that the pigment was changed to C.I. pigment blue 15:3.

### (Pigment Dispersion 3)

Pigment dispersion 3 in which the content of the pigment was 10.0%, and the content of the resin dispersant (resin 1) was 3.0% was prepared in accordance with the same procedure as the above-described pigment dispersion 1 except that the pigment was changed to C.I. pigment red 122.

### (Pigment Dispersion 4)

Pigment dispersion 4 in which the content of the pigment was 10.0%, and the content of the resin dispersant (resin 1) was 3.0% was prepared in accordance with the same procedure as the above-described pigment dispersion 1 except that the pigment was changed to C.I. pigment yellow 74.

### [Preparation of Ink]

After components (unit: %) shown in Table 1 below were mixed and sufficiently stirred, the mixture was filtered under pressure using a cellulose acetate filter with a pore size of 3.0 μm (available from ADVANTEC), thereby preparing each ink. “ACETYLENOL E100” is the product name of a surfactant available from Kawaken Fine Chemicals.

TABLE 1
Ink Compositions

| | Black Ink | Cyan Ink | Magenta Ink | Yellow Ink |
|---|---|---|---|---|
| Pigment | 35.0 | | | |
| Dispersion 1 | | | | |
| Pigment | | 35.0 | | |
| Dispersion 2 | | | | |
| Pigment | | | 35.0 | |
| Dispersion 3 | | | | |
| Pigment | | | | 35.0 |
| Dispersion 4 | | | | |
| Aqueous | 24.0 | 24.0 | 24.0 | 24.0 |
| Dispersion of | | | | |
| Resin Particles | | | | |
| 1,2-Propanediol | 15.0 | 15.0 | 15.0 | 15.0 |
| Acetylenol E100 | 0.5 | 0.5 | 0.5 | 0.5 |
| Pure Water | 25.5 | 25.5 | 25.5 | 25.5 |

### [System Configuration]

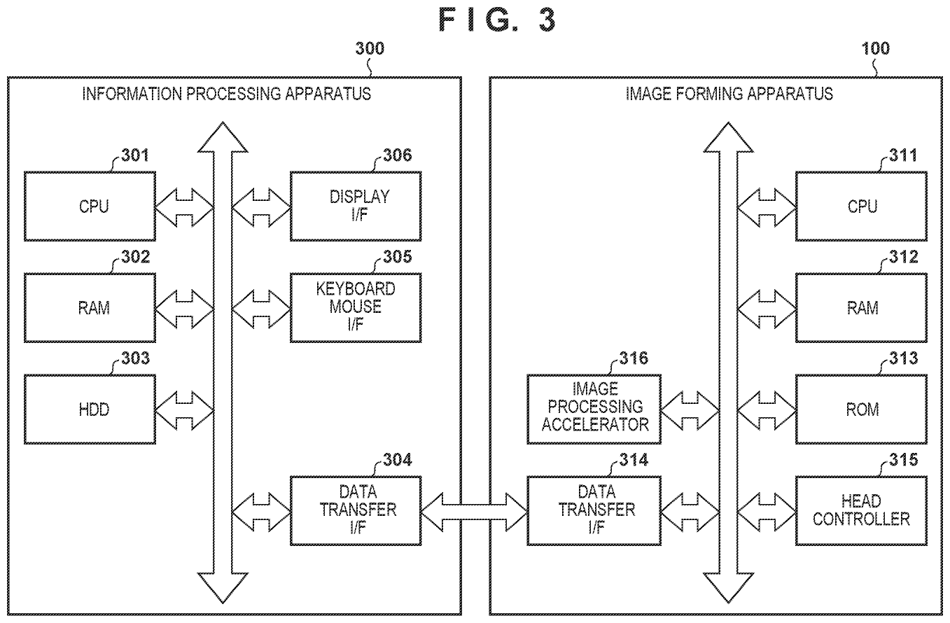

FIG. 3 is a block diagram showing an example of the overall configuration of a system including the image forming apparatus 100 according to this embodiment. As shown in FIG. 3, the system according to this embodiment is formed by the image forming apparatus 100 shown in FIG. 1 and an information processing apparatus (PC) 300 serving as a host apparatus thereof.

The information processing apparatus 300 includes a Central Processing Unit (CPU) 301, a Read Only Memory (RAM) 302, a Hard Disk Drive (HDD) 303, a communication I/F 304, an input device I/F 305, and a display device I/F 306. The function units provided in the information processing apparatus 300 are communicably connected to each other by an internal bus. The CPU 301 executes processing according to programs and various kinds of data held in the HDD 303 or the RAM 302. The RAM 302 is a volatile storage, and temporarily holds programs and data. The HDD 303 is a nonvolatile storage, and stores programs and data.

The communication I/F 304 is an interface for controlling communication with an external apparatus, and here controls data transmission/reception to/from the image forming apparatus 100. As a connection method for data transmission/reception here, wired connection such as USB, IEEE1394, or Local Area Network (LAN) or wireless connection such as Bluetooth® or WiFi® can be used. The input device I/F 305 is an interface for controlling a Human Interface Device (HID) such as a keyboard or a mouse, and accepts an input of a user from an input device. The display device I/F 306 controls display on a display device such as a display (not shown).

Here, the information processing apparatus 300 will be described below as a PC separate from the image forming apparatus 100. However, the implementation mode is not limited to this if similar processing can be performed. For example, the information processing apparatus 300 may be an apparatus incorporated in the image forming apparatus 100, or may be a server. Also, for example, the information processing apparatus 300 may be a portable terminal such as a smartphone, a tablet terminal, or an image capturing device.

The image forming apparatus 100 includes a CPU 311, a RAM 312, a ROM 313, a communication I/F 314, a head controller 315, and an image processing accelerator 316. The function units provided in the image forming apparatus 100 are communicably connected to each other by an internal bus. The CPU 311 executes processing according to embodiments to be described later in accordance with programs and various kinds of data held in the ROM 313 or the RAM 312. The RAM 312 is a volatile storage, and temporarily holds programs and data. The ROM 313 is a nonvolatile storage, and stores various kinds of data such as table data and programs that are used in processing to be described later.

The communication I/F 314 is an interface for controlling communication with an external apparatus, and here controls data transmission/reception to/from the information processing apparatus 300. The head controller 315 performs control of the printing unit 101 shown in FIG. 1 based on formation data. More specifically, the head controller 315 can be configured to load control parameters and formation data from a predetermined address of the RAM 312.

When the CPU 311 writes the control parameters and the formation data to a predetermined address of the RAM 312, the head controller 315 starts image formation processing, and the printing unit 101 performs an ink discharge operation. The image processing accelerator 316 (to be referred to as the accelerator 316 hereinafter) is formed by hardware, and can execute image processing at a higher speed than the CPU 311. More specifically, the accelerator 316 may be configured to load parameters and data necessary for image processing from a predetermined address of the RAM 312. Here, when the CPU 311 writes the parameters and the data to a predetermined address of the RAM 312, the accelerator 316 is activated, and predetermined image processing is performed. Note that the accelerator 316 is not an indispensable element, and image processing to be described below may be executed only by processing of the CPU 311 in accordance with the specifications of the image forming apparatus.

### [Image Processing]

Image processing performed by the image forming apparatus 100 will be described below. This image processing is implemented by, for example, the CPU 311 of the image forming apparatus 100 reading out a program and data included in the ROM 313 or the like and executing these. Note that the processing may be partially or wholly executed by the accelerator 316. Alternatively, the processing may be partially or wholly executed by the CPU 301 of the information processing apparatus 300 reading out a program and data included in the HDD 303 or the like.

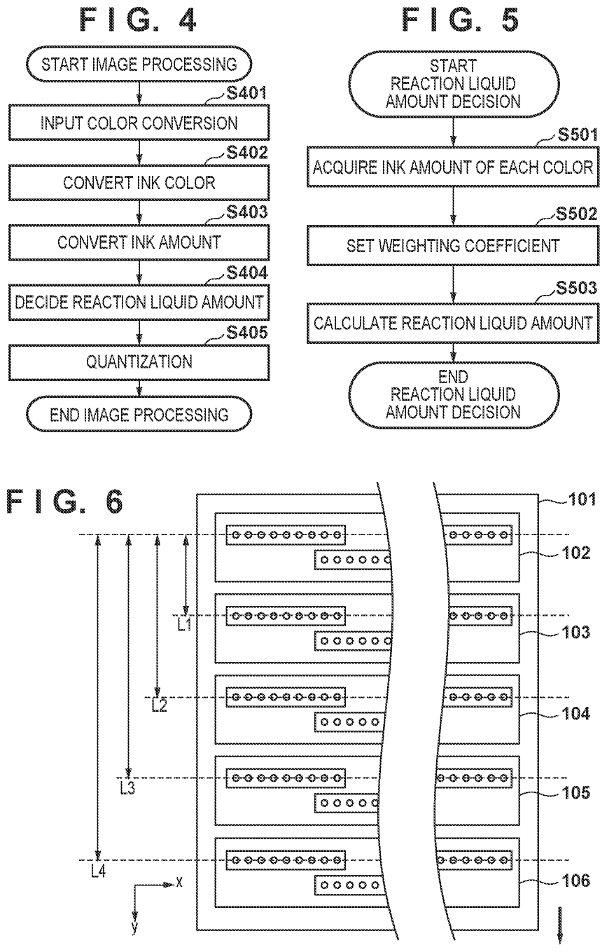

FIG. 4 is a flowchart showing an example of image processing performed by the image forming apparatus 100 according to this embodiment. Hereinafter, a simple term “image processing” indicates this image processing.

In step S401, the image forming apparatus 100 converts input image data into image data corresponding to the color reproduction region of the image forming apparatus 100. In this embodiment, the input image data is assumed to be data representing color coordinates (R, G, B) in color space coordinates such as sRGB that are expression colors of a monitor. The image forming apparatus 100 according to this embodiment converts input image data of RGB (each value is expressed by 8 bits) into image data (R′, G′, B′) in the color reproduction region of the image forming apparatus 100 by a known method such as matrix operation processing or processing using a three-dimensional lookup table (3DLUT). In this embodiment, a 3DLUT is used, and an interpolation operation is used together, thereby performing conversion processing. The format of the input image is not limited to that described above and, for example, input image data of CMYK can also be used. In this case, the image data can be converted by processing using a four-dimensional LUT, or the like.

In step S402, the image forming apparatus 100 converts the RGB image data processed in step S401 into image data by color signal data of color inks used in the image forming apparatus 100. In this embodiment, since black (K), cyan (C), magenta (M), and yellow (Y) inks are used, image data of RGB signals is converted into image data formed by 8-bit K, C, M, and Y color signals. Color conversion processing of step S402 can be performed using a 3DLUT and an interpolation operation, as in step S401. Note that as another conversion method, a method such as matrix operation processing may be used, as in step S401. As for the number of inks, four color inks of K, C, M, and Y have been described as an example. Another ink may be added, and some inks may not be used.

In step S403, the image forming apparatus 100 converts the image data of CMYK signals into ink amount signal values corrected such that these correspond to the number of dots in image formation. As a method of conversion to the ink amount signal values, an arbitrary method such as a method of performing y adjustment using a one-dimensional LUT can be employed. Here, the ink amount signal value is information representing an ink discharge amount in image formation.

In step S404, the image forming apparatus 100 decides a reaction liquid amount signal value representing the discharge amount of the reaction liquid based on the ink amount signal values of the color inks of the respective types (ink colors) processed in step S403 and a reaction liquid decrease amount to be described later. Details of step S404 will be described later.

In step S405, the image forming apparatus 100 performs quantization processing for the ink amount signal value of the reaction liquid and the ink amount signal values K, C, M, and Y of the color inks, and ends the processing shown in FIG. 4. In quantization processing, various quantization levels such as binarization or ternarization to hexadecimalization exist. Generally, at the time of binarization processing, the ink amount signal value of the reaction liquid and the ink amount signal values K, C, M, and Y of the color inks are converted into 1-bit P, K, C, M, and Y data with ink dots or data without ink dots. As the quantization processing method, pseudo halftone processing such as a known dither matrix method or an error diffusion method may be used.

### [Image Formation Processing]

The image forming apparatus 100 transfers the data that has undergone the quantization processing in step S405 to the head controller 315, and discharges the reaction liquid and the color inks of the respective colors from the printing elements 201, thereby forming an image on a print medium. Even after completion of the image formation processing, the image forming apparatus 100 can store the quantized data in the RAM 312 for a predetermined time.

### [Decision of Reaction Liquid Amount]

A method of deciding the discharge amount of the reaction liquid used in image formation, which is performed by the image forming apparatus 100 according to this embodiment, will be described below. The decision processing of the discharge amount of the reaction liquid is performed in the reaction liquid amount calculation portion S404 in FIG. 4. Note that the following description will be made assuming that the reaction liquid amount used for a color ink equals the amount of the color ink regardless of the type of ink.

The image forming apparatus 100 according to this embodiment decides the discharge amount (reaction liquid amount) of the reaction liquid discharged before ink based on the decrease amount of the reaction liquid on the print medium after the discharge of the reaction liquid and the discharge amount of ink. For example, the image forming apparatus 100 can set a weight coefficient according to the type of ink based on the decrease amount and decide the reaction liquid amount based on the weight coefficient and the discharge amount of the ink. In this embodiment, a reaction liquid amount Pr(COLₙ) used for one color ink is calculated by, for example,

$$Pr ( {COL}_{n} ) = V ( {COL}_{n} ) \times W ( {COL}_{n} ) \qquad ( 1 )$$

where V(COLₙ) is an ink amount, and W(COLₙ) is the weight coefficient. In equation (1), COLₙ is a value individually prepared for each type of ink (total number n), and here, COL₁ to COL₄ correspond to K, C, M, and Y, respectively. For example, a reaction liquid amount corresponding to the K ink can be expressed as Pr(K) (or Pr(COLₙ)). A procedure of calculating the reaction liquid amount using equation (1) will be described below together with the processing procedure.

FIG. 5 is a flowchart showing an example of reaction liquid amount decision processing performed by the image formation processing 100 according to this embodiment. In step S501, the image forming apparatus 100 specifies the type of ink used in equation (1), and acquires an amount V(COLₙ) of each specified type of ink. Here, the image forming apparatus 100 can acquire, for example, the ink amount signal values of K, C, M, and Y calculated in step S403 as color ink amounts V(K), V(C), V(M), and V(Y), respectively.

In step S502, the image forming apparatus 100 sets a weight coefficient according to the type of ink (corresponding to each ink). After the reaction liquid lands on the print medium, along with the elapse of time, the reaction liquid amount remaining on the surface layer of the print medium decreases due to absorption into the print medium or evaporation. For this reason, the larger the time difference from discharge of the reaction liquid to discharge amount of each ink is, the smaller the reaction liquid amount remaining on the print medium surface layer at the time of ink landing is. If the reaction liquid amount remaining on the surface layer is short at the time of landing of ink on the print medium, the ink cannot sufficiently be fixed on the print medium. This may cause density lowering or image unevenness, or image deletion may occur due to the influence of wind or gravity generated by conveyance. From this viewpoint, the image forming apparatus 100 according to this embodiment sets the weight coefficient in accordance with the type of ink and the decrease amount of the reaction liquid on the print medium from the discharge of the reaction liquid onto the print medium to the discharge of the ink. That is, an ink fixing failure is suppressed by setting a weight coefficient that compensates for the decrease of the reaction liquid on the print medium.

Note that the time difference generated from discharge of the reaction liquid or each color ink to landing on the print medium surface is sufficiently small and is therefore neglected, and in this embodiment, the description will be made based on the discharge time as the reference. However, the time difference from discharge of the reaction liquid to discharge amount of each ink may be calculated in consideration of the time difference until landing, and various kinds of calculations may be performed based on not the discharge time but the time of landing on the print medium as the reference.

A decrease amount ΔPr(COLₙ) (to be simply referred to as a “reaction liquid decrease amount” hereinafter) of the reaction liquid on the print medium from the discharge of the reaction liquid to the discharge of the ink, which is used to calculate the weight coefficient according to this embodiment, is calculated by

$$Δ Pr ( {COL}_{n} ) = Pv \times t ( {COL}_{n} ) \qquad ( 2 )$$

where Pv is the decrease speed of the reaction liquid per time, and t(COLₙ) is the discharge time difference between the reaction liquid and the color ink. The decrease speed Pv of the reaction liquid can be calculated in advance based on a time required from discharge of a predetermined amount of reaction liquid onto the print medium to absorption into the print medium and evaporation. As a method of measuring the time required until absorption of the reaction liquid into the print medium and evaporation, a method is usable in which, for example, the print medium is observed using a digital microscope, a luminance variation on a unit area immediately after the reaction liquid discharge is observed, and time until the luminance variation does not occur any more is measured. Since the time required for absorption and evaporation varies depending on the material or structure of the print medium, the value of the decrease speed of the reaction liquid can also change depending on the type of print medium. That is, in this embodiment, the reaction liquid decrease amount may be acquired further based on the type of print medium to form an image.

Note that in this embodiment, the reaction liquid decrease amount ΔPr(COLₙ) is calculated in proportion to the time difference t(COLₙ) using equation (2). However, if ΔPr is not proportional to the elapsed time, for example, in a case where the reaction liquid decrease amount becomes small along with the increase of the time difference t(COLₙ), ΔPr may be acquired by another method. For example, ΔPr may be calculated using an equation different from equation (2). A table recording ΔPr corresponding to t(COLₙ) may be stored in advance, and ΔPr may be acquired by looking up the table.

t(COLₙ) indicating the discharge time difference between the reaction liquid and ink corresponds to the time for the print position of a target on the print medium to relatively move to the discharge position of ink based on the discharge position of the reaction liquid as the reference. In the full line type image forming apparatus 100, t(COLₙ) can be obtained by

$$t ( {COL}_{n} ) = l ( {COL}_{n} ) \div Cv \qquad ( 3 )$$

where l(COLₙ) is the distance between the discharge position of the reaction liquid and the discharge position of the ink, and Cv is the relative moving speed between the printing unit (printing elements) and the print medium. FIG. 6 is a view for explaining an example of the distance l(COLₙ) from discharge of the reaction liquid to discharge of an ink in the printing unit 101 according to this embodiment. The image forming apparatus 100 according to this embodiment is of a full line type, and the distance from a printing elements that discharge the reaction liquid to a printing elements that discharge an ink is defined as the distance between the discharge position of the reaction liquid and the discharge position of the ink. In FIG. 6, L1 to L4 indicate the distances from the printhead 102 that discharges the reaction liquid to the printheads 103 to 106 of the inks. For example, since the distance from the printhead 102 of the reaction liquid to the printhead 103 of the K ink is represented by L1, l(K)=L1.

The relative moving speed Cv according to this embodiment indicates the speed for the position where image formation is performed to relatively move from the position of the printhead that discharges the reaction liquid to the position of the printhead that discharges each ink due to conveyance of the print medium. The relative moving speed Cv can be set in accordance with the speed setting at the time of print medium conveyance of the image forming apparatus 100. If the position of the printing unit 101 also moves in addition to the conveyance of the print medium, the relative moving speed Cv may be set in consideration of the movement of the printing unit 101 as well.

As shown by equation (3), in the full line type image forming apparatus 100, since the time difference t(COLₙ) varies in proportion to the distance l(COLₙ), the larger l(COLₙ) is, the larger t(COLₙ) is. Also, in equation (2), the larger the time difference t(COLₙ) is, the larger the reaction liquid decrease amount ΔPr(COLₙ) is. In other words, the larger the distance l(COLₙ) is, the larger the decrease amount of the reaction liquid until discharge of each ink is.

Note that in this embodiment, the reaction liquid decrease amount ΔPr is decided based on equation (2). However, the reaction liquid decrease amount may be acquired by another method, as described above. For example, a table that outputs a reaction liquid decrease amount calculated in advance may be stored, and the reaction liquid decrease amount may be decided by inputting the relative moving speed of the print medium and the discharge time difference between the reaction liquid and an ink.

Processing of acquiring the reaction liquid decrease amount for each ink has been described above. Processing of setting a weight coefficient based on the acquired reaction liquid decrease amount will be described next. The image forming apparatus 100 according to this embodiment sets a weight coefficient based on the type of ink and the reaction liquid decrease amount as described above, to compensate for the reaction liquid decrease amount. Here, for example, in accordance with equation (4) below, a weight coefficient W(COLₙ) corresponding to each ink can be calculated, for each ink, using a value obtained by subtracting the reaction liquid decrease amount ΔPr(COLₙ) from a reaction liquid discharge amount PV₀ (reference reaction liquid amount).

$$W ( {COL}_{n} ) = \frac{{PV}_{0}}{{PV}_{0} - Δ Pr ( {COL}_{n} )} \qquad ( 4 )$$

The reference reaction liquid amount PV₀ in equation (4) may be decided by, for example, the reaction liquid amount necessary for the assumed maximum discharge amount of ink, and can arbitrary be set in accordance with a desired condition or the environment. If the necessary reaction liquid amount changes depending on the type of ink, the reference reaction liquid amount PV₀ may be changed for each ink.

In step S503, the image forming apparatus 100 decides the reaction liquid amount to be actually discharged. Here, the reaction liquid amount for each ink is calculated using the weight coefficient calculated using equation (4), and the sum thereof can be decided as the reaction liquid amount to be actually discharged. In this embodiment, the image forming apparatus 100 adds the weight coefficients W(COLₙ) calculated for the inks in step S502, thereby deciding the reaction liquid amount. For example, a reaction liquid amount VP can be calculated by

$$VP = {\sum }_{n = 1}^{CN} V ( {COL}_{n} ) \times W ( {COL}_{n} ) \qquad ( 5 )$$

where CN is the total number of ink types. Since CMYK inks are used here, CN is 4.

According to this processing, since the discharge amount of the reaction liquid is decided in consideration of the reaction liquid decrease amount, image formation using an appropriate reaction liquid amount can be performed while compensating for the decrease amount.

Note that in this embodiment, the description has been made assuming that the reaction liquid amount to be used does not change depending on the type of ink. However, the reaction liquid amount may change depending on the type of ink. That is, the reference reaction liquid amount PV₀ may change depending on the type of ink.

Processing performed by the image forming apparatus 100 according to this embodiment will be described next using a detailed example. In this example, the relative moving speed Cv used in equation (3) is 100 m/s, and the decrease speed Pv of the reaction liquid obtained by measurement is 1 pl/s. The reaction liquid decrease amount ΔPr(COLₙ) of each ink is calculated based on the reaction liquid decrease speed Pv and the discharge time difference t(COLₙ) between the reaction liquid and ink, as shown in equation (2).

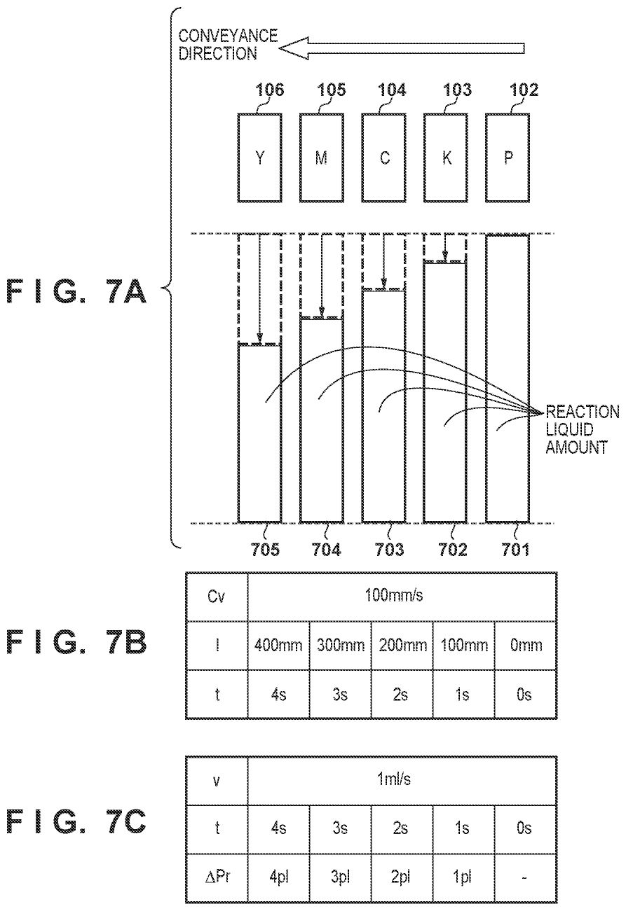

FIGS. 7A, 7B, and 7C show the reaction liquid amounts in image formation by the printheads 103 to 106 of the respective colors, which decrease in accordance with the distance from the printhead 102 that discharges the reaction liquid P. A reaction liquid amount 701 indicates the whole reaction liquid amount. Reaction liquid amounts 702 to 705 indicate reaction liquid amounts in image formation by the printing elements of K, C, M, and Y, respectively. In the reaction liquid amounts 702 to 705, a broken line portion corresponds to the decrease amount of the reaction liquid in image formation, and a solid line portion corresponds to the reaction liquid amount after decrease.

As shown in FIG. 7A, as for the reaction liquid amount 701 discharged from the printhead 102 of the reaction liquid, the reaction liquid amount on the print medium at the time of ink discharge decreases every time the print medium is conveyed to the printheads 103 to 106 of the color inks, and the time difference becomes large. FIG. 7B shows an example of detailed numerical values of the distance l(COLₙ) between the reaction liquid discharge position and the ink discharge position, and calculation results of the discharge time difference t(COLₙ) between the reaction liquid and ink, which is obtained by the value and the relative moving speed Cv. Here, concerning the Y, C, M, and K colors, the distances l(COLₙ) are 400 mm, 300 mm, 200 mm, and 100 mm, and the differences t(COLₙ) are obtained as 4 s, 3 s, 2 s, and is from equation (3). As shown in FIG. 7B, in this embodiment, the larger the distance l(COLₙ) between the reaction liquid discharge position and the color ink discharge position is, the larger the value of the discharge time difference t(COLₙ) between the reaction liquid and the color ink is.

Also, FIG. 7C shows the calculation results of the reaction liquid decrease amount ΔPr(COLₙ) calculated based on the discharge time difference t(COLₙ) between the reaction liquid and the ink shown in FIG. 7B and the decrease speed Pv of the reaction liquid. Here, concerning the Y, C, M, and K colors, the reaction liquid decrease amounts ΔPr(COLₙ) are calculated as 4 pl, 3 pl, 2 pl, and 1 pl, respectively, from equation (2). As shown in FIG. 7C, the larger the discharge time difference t(COLₙ) between the reaction liquid and the color ink is, the larger the reaction liquid decrease amount ΔPr(COLₙ) is.

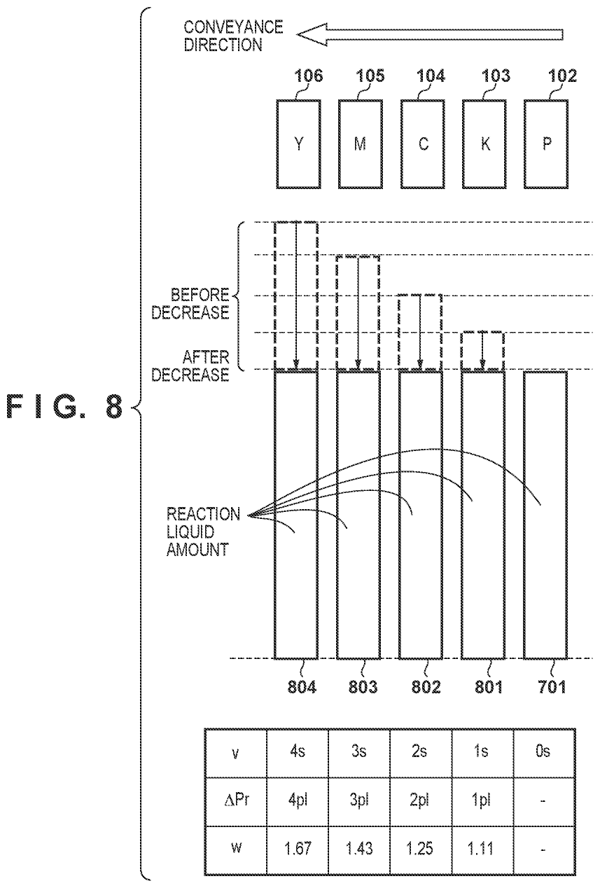

Next, weight coefficient calculation processing is performed. In this example, a description will be made assuming that the reference reaction liquid amount PV₀ is 10 pl. FIG. 8 is a view for explaining the reaction liquid to be compensated for using a weight coefficient. Reaction liquid amounts 801 to 804 shown in FIG. 8 indicate reaction liquid amounts in image formation compensated for using the weight coefficients by the printing elements of K, C, M, and Y. In this embodiment, as shown in FIG. 8, the weight coefficient is set such that the reaction liquid amount is sufficiently kept even if the reaction liquid amount decreases.

A table in FIG. 8 shows the weight coefficients W for the color inks calculated based on the reaction liquid decrease amounts ΔPr(COLₙ) using, as an example, a case where the reference reaction liquid amount PV₀ is 10 pl. The table also shows the association between the time difference t(COLₙ) generated from reaction liquid discharge to the discharge of each color ink and the weight coefficient W(COLₙ). Here, the weight coefficients (COLₙ) of the Y, M, C, and K are obtained as 1.67, 1.43, 1.25, and 1.11, respectively, from equation (4). In this example, as shown in FIG. 8, adjustment is performed such that the larger the discharge time difference t(COLₙ) between the reaction liquid and the color ink is, and the larger the reaction liquid decrease amount ΔPr(COLₙ) is, the larger the value of the weight coefficient W is, and the larger the reaction liquid amount is.

Next, the image forming apparatus 100 decides the reaction liquid amount VP based on the amount V(COLₙ) of each color ink and the weight coefficient (COLₙ) corresponding to each color ink. For example, if the color ink amounts of Y, M, C, and K are 8 pl, 4 pl, 4 pl, and 3 pl, respectively, the reaction liquid amount VP is obtained by

$$\begin{matrix}VP = {\sum }_{n = 1}^{CN} V ( {COL}_{n} ) \times W ( {COL}_{n} ) \\ = 8 \times 1.67 + 4 \times 1.43 + 4 \times 1.25 + 8 \times 1.11 \\ = 32.96 [ pl ]\end{matrix}$$

The total amount of color ink amounts is 24 pl. However, as is calculated by the above-described calculation, the reaction liquid amount is adjusted to be large in consideration of the weight coefficient W(COLₙ) of each color ink.

As described above, in the example shown in FIG. 8, the reaction liquid amount is changed by weighting in accordance with the decrease amount of the reaction liquid on the print medium. Furthermore, for a color ink for which the time difference from discharge of the reaction liquid is large, and the reaction liquid decrease amount is large, the reaction liquid amount to be generated becomes large. According to this processing, even if the reaction liquid amount decreases along with the elapse of time, it is possible to suppress shortage of the reaction liquid amount at the time of landing of ink, and appropriate reaction can be held.

Note that the weight coefficient may be calculated as needed by giving a necessary input value during image processing. A value calculated in advance may be stored at a predetermined address for each print mode, and loaded and used when calculating the reaction liquid amount.

Note that in this embodiment, the description has been made assuming that the reaction liquid amount for the reaction liquid decrease amount is compensated for by calculating the weight coefficient W(COLₙ) based on the reaction liquid decrease amount in accordance with equation (4). However, such processing need not particularly be performed if the reaction liquid amount can be compensated for in accordance with the reaction liquid decrease amount. For example, the reaction liquid amount may be added in accordance with the reaction liquid decrease amount. For example, a value obtained by totalizing the reaction liquid decrease amounts ΔPr(COLₙ) calculated for the respective colors and adding the sum to the reference reaction liquid amount PV₀ may be decided as the discharge amount of the reaction liquid.

Also, for example, the description has been made assuming that the discharge amount of the reaction liquid linearly changes in accordance with the reaction liquid decrease amount. However, the present invention is not particularly limited to this. For example, the discharge amount may be set stepwise such that if the reaction liquid decrease amount is equal to or larger than a first threshold and less than a second threshold, the discharge amount of the reaction liquid is set to a first discharge amount, and if the reaction liquid decrease amount is equal to or larger than the second threshold and less than a third threshold, the discharge amount of the reaction liquid is set to a second discharge amount. The thresholds here can arbitrarily be set by the user.

### Second Embodiment

The image forming apparatus 100 according to the first embodiment calculates the discharge amount (reaction liquid amount) of the reaction liquid for each ink based on the type of ink and the reaction liquid decrease amount. More specifically, the image forming apparatus 100 according to the first embodiment sets the weight coefficient based on the reaction liquid decrease amount, thereby implementing changing the reaction liquid amount for each ink amount. On the other hand, an image forming apparatus 100 according to the second embodiment decides a reaction liquid amount using a weight coefficient (here, based on a LUT that outputs a reaction liquid amount) based on an input of an ink amount. The following description will be made assuming that the reaction liquid amount used for a color ink equals the amount of the color ink regardless of the type of ink.

### [Reaction Liquid Amount Calculation Processing]

The image forming apparatus 100 according to this embodiment can perform the same processing as the procedure shown in FIG. 4 according to the first embodiment except that the process of step S404 is different. In step S404, using a lookup table (LUT), a CPU 301 according to this embodiment decides a reaction liquid amount (P) based on the color ink amounts (K, C, M, and Y) imparted in a predetermined region. Step S404 executed by the image forming apparatus 100 according to this embodiment will be described below.

If the reaction liquid amount is too small, a beading phenomenon may occur in which ink is not sufficiently fixed, adjacent dots pull each other due to surface tension, and unevenness is caused by irregular gaps. On the other hand, if the reaction liquid amount is too large, image unevenness may occur due to cracks in an ink film or ink buried in a reaction liquid film. For this reason, the reaction liquid is preferably set to an appropriate amount.

Here, assume a case where “reaction liquid”, “ink on the upstream side (in the conveyance direction)”, and “ink on the downstream side (in the conveyance direction)” are sequentially imparted to a sheet that a liquid readily permeates. As a type of sheet that a liquid readily permeates, general coated paper coated with a coating layer can be used. Here, it indicates a sheet for which the permeation speed of a test solution having a surface tension of 35 mN/m and a viscosity of 2 mPa·s falls within the range of 0.5 to 30 μm/s². The permeation speed can be evaluated by a minimum contact angle meter MCA available from Kyowa Interface. In this embodiment, a second amount of reaction liquid imparted when a first amount of ink on the upstream side is imparted is smaller than a third amount of reaction liquid imparted when the first amount of ink on the downstream side is imparted.

Note that here, “the sheet that a liquid readily permeates” is assumed to be a sheet for which the permeation speed of the reaction liquid in the sheet is a predetermined speed or more. A description will be made below assuming that the sheet of above-described example is used as “the sheet that a liquid readily permeates”, and various kinds of values may be changed in accordance with a condition desired by the user or the environment. On the other hand, as “a sheet that a liquid hardly permeates”, here, a sheet for which the permeation speed of a test solution having a surface tension of 35 mN/m and a viscosity of 2 mPa·s is less than 0.5 μm/s² is used. As a type of sheet that a liquid hardly permeates, for example, a sheet using a film of PET or PP can be used. As described above, the image forming apparatus 100 can classify a print medium to a sheet that a liquid readily permeates or a sheet that a liquid hardly permeates based on, for example, the permeation speed of the liquid (the absorption speed into the print medium).

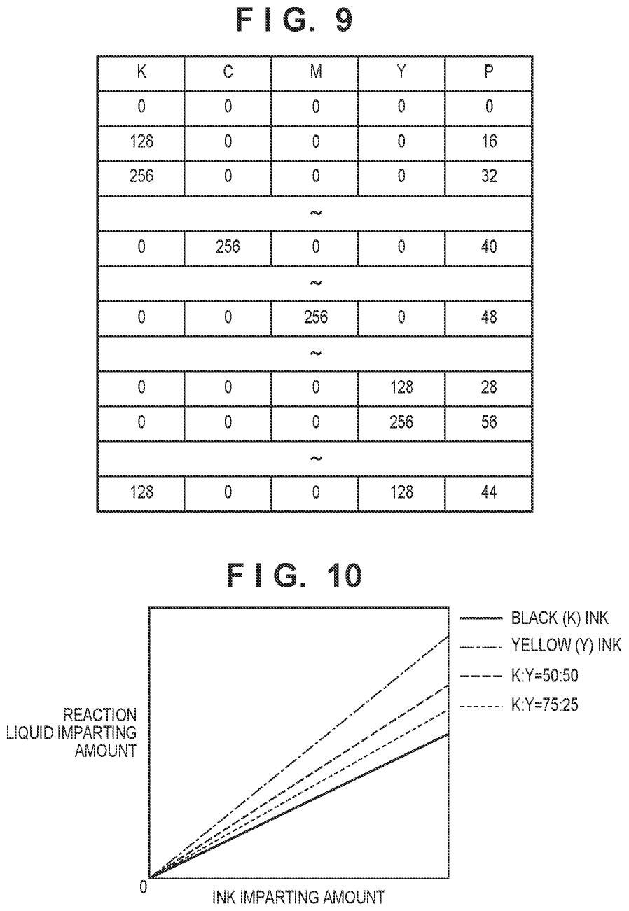

FIG. 9 is a view showing an LUT to be looked up when deciding the reaction liquid amount in this embodiment. FIG. 9 shows a four-dimensional LUT that decides, using CMYK values as an input, the discharge amount of the reaction liquid to be imparted to the sheet that a liquid readily permeates. Numbers in four columns on the left side in the LUT shown in FIG. 9 indicate, as 8-bit signals, ink amount signal values of the respective ink colors processed in step S403. The rightmost column in the LUT shown in FIG. 9 shows the imparting amount signal value of the reaction liquid (P) decided by the combination of the ink amount signal values of the respective ink colors. That is, in the four-dimensional LUT shown in FIG. 9, a reaction liquid amount is associated with a combination of the amounts of the plurality of types of ink.

In this embodiment, the reaction liquid amount corresponding to the ink amount of each color is smaller for the ink color of the printhead close to the printhead of the reaction liquid concerning the conveyance direction of a sheet S. This is obtained by considering the amount of the reaction liquid decreased from the sheet surface because of permeation into the sheet until the ink of each color is imparted after the reaction liquid is imparted. With this relationship of the reaction liquid amount, image formation can be performed while suppressing image unevenness.

Note that in FIG. 9, values other than that in the lowermost row indicate imparting amount signal values of the reaction liquid (P) for primary colors (colors that can be obtained only by one type of ink). On the other hand, the lowermost row of the LUT shown in FIG. 9 shows an integrated value of reaction liquid amounts needed by the inks in the amounts for each secondary color (a color obtained by mixing two or more color inks). For example, in the example of the lowermost row shown in FIG. 9, the signal value is “44” that is the sum of a P signal value (here, 16) corresponding to a K signal value (here, 128) and a P signal value (here, 28) corresponding to a Y signal value (here, 128).

FIG. 10 is a view for explaining reaction liquid amount decision processing according to this embodiment. FIG. 10 is particularly a view for explaining processing of generating an LUT to be looked up in reaction liquid amount decision processing. Here, FIG. 10 shows a graph indicating an imparting amount of the reaction liquid corresponding to an ink imparting amount. Here, for the sake of simplicity, a description will be made only concerning two colors, that is, the K ink on the upstream side in the conveyance direction (closer to the printhead of the reaction liquid) and the Y ink on the downstream side (farther from the printhead of the reaction liquid). In the graph of FIG. 10, the ink imparting amount is plotted along the X-axis, and the imparting amount of the reaction liquid is plotted along the Y-axis.

In FIG. 10, for both ink colors, the larger the imparting amount is (that is, toward the right side of the X-axis), the larger the reaction liquid amount to be imparted is. Also, the reaction liquid amount to be imparted is smaller for the K ink on the upstream side than for the Y ink even if the ink imparting amounts are equal. In a region where the two color inks are imparted at a ratio of 50:50, an intermediate reaction liquid amount between reaction liquid amounts for the inks that are imparted alone is imparted. When imparting the K and Y inks at a ratio of 75:25, an intermediate reaction liquid amount between the reaction liquid imparting amount in the above-described case where the inks are imparted at a ratio of 50:50 and that in a case where only the black ink is imparted is imparted.

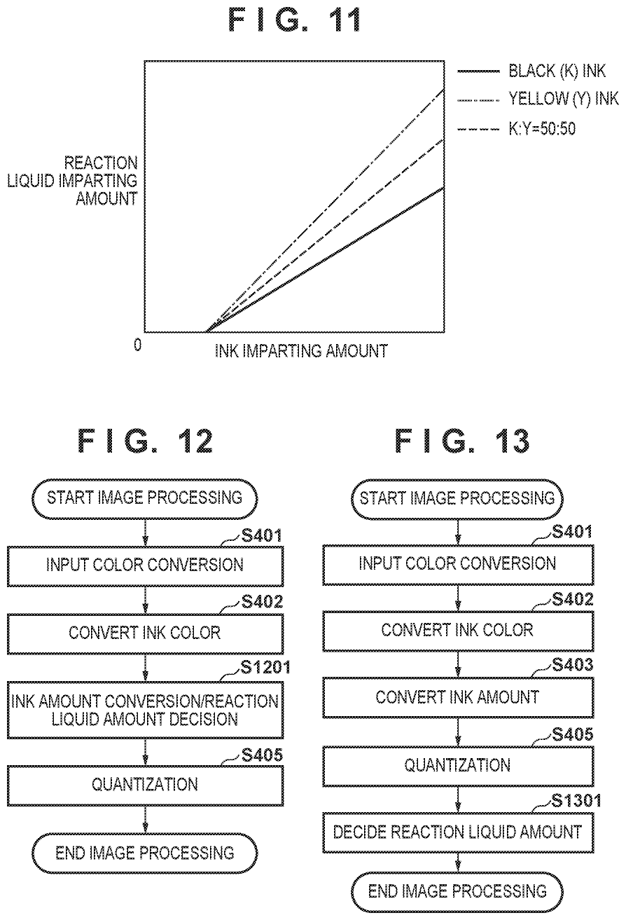

Note that in FIG. 10, the reaction liquid amount is decided in proportion to the ink imparting amount. However, the relationship between the ink imparting amount and the reaction liquid imparting amount is not particularly limited to this, if the reaction liquid imparting amount can be decided based on the ink imparting amount. For example, if the ink imparting amount falls within a predetermined range, like a correspondence relationship in an LUT exemplarily shown in FIG. 11, the reaction liquid may not be imparted (the reaction liquid imparting amount may be set to zero).

Note that in this embodiment, like the processing shown in FIG. 4, after ink amount conversion processing (step S403), processing of deciding the reaction liquid amount (step S404) is performed. However, the order of processes is not particularly limited to this. For example, the image forming apparatus 100 may perform ink amount conversion processing and reaction liquid amount decision together (simultaneously) after step S402. FIG. 12 shows an example of processing in a case where ink amount conversion processing and reaction liquid amount decision are performed simultaneously (step S1206) in place of steps S403 and S404 in FIG. 4. This processing can be implemented by, for example, storing reaction liquid amount signal values together in the LUT in ink amount conversion.

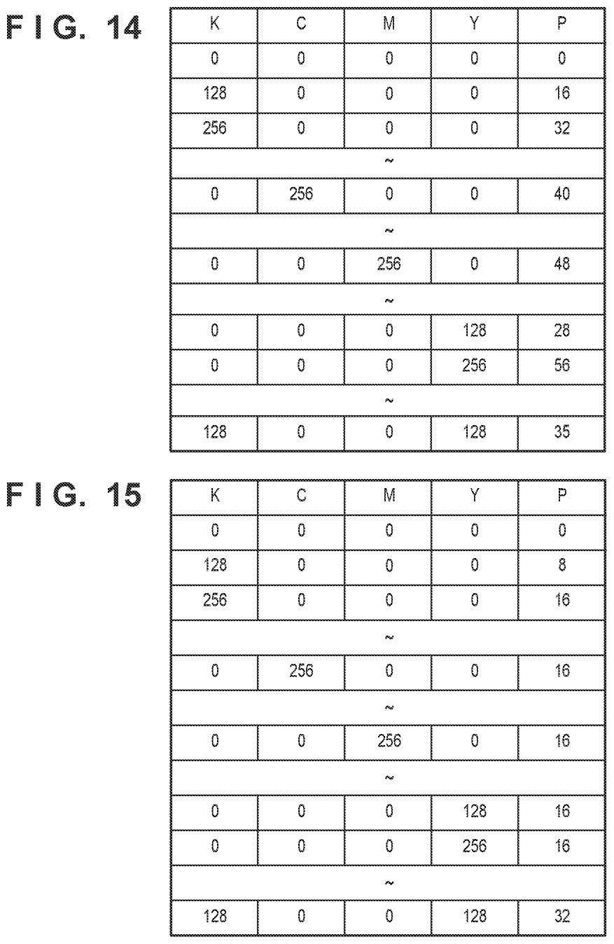

As still another method, the image forming apparatus 100 may perform the reaction liquid amount decision processing after ink amount conversion and quantization processing. Here, the image forming apparatus 100 may decide the reaction liquid amount by arithmetic processing or processing using an LUT in accordance with the ink amount for each pixel. For example, when decreasing the reaction liquid imparting amount only for a multiple order color (For example, using an LUT shown in FIG. 14 according to the first modification to be described later), the reaction liquid amount may be decided after quantization. FIG. 13 shows an example of such processing. The processing shown in FIG. 13 is performed in accordance with the same procedure as the processing shown in FIG. 4 except that step S404 is not performed, and the reaction liquid amount is decided in step S1301 performed next to step S405, and a description thereof will be omitted here. According to the processing shown in FIG. 13, control can more easily be performed on a pixel basis by, for example, decreasing the reaction liquid imparting amount for a pixel on which the imparting amounts of the colors of a multiple order color substantially equal.

### [Effects]

Image formation was performed using an image forming system shown in FIG. 1, and effects were confirmed. Note that “parts” and “%” concerning component amounts are on a mass basis unless otherwise specified. As a reaction liquid and inks, those described in the first embodiment were used.

As the sheet S that was a medium to print, “ART E PW 8K” available from LINTEC which a liquid readily permeated was used. When evaluation was done using a minimum contact angle meter MCA available from Kyowa Interface, the permeation speed of a test solution having a surface tension of 35 mN/m and a viscosity of 2 mPa·s was 4 to 6 μm/s². The sheet conveyance speed was 0.2 m/s, and the gap between the printheads was 150 mm. Here, the LUT shown in FIG. 9 was used to decide the reaction liquid amount, the maximum imparting amount of each color ink was 20 g/m², and the maximum imparting amount of the reaction liquid was 5 g/m². As a result of forming an image under the above-described conditions, it was confirmed that image unevenness was suppressed on the sheet that a liquid readily permeated.

As described above, according to the processing of the second embodiment, in inkjet printing, the imparting amount of the reaction liquid is decided in consideration of the time difference from reaction liquid imparting for ink to ink imparting. More specifically, control is performed such that the larger the time difference from reaction liquid imparting to ink imparting is, the larger the imparting amount of the reaction liquid is. This makes it possible to suppress an image formation failure (for example, image unevenness) when an image is formed on a sheet that a liquid (the reaction liquid or ink) readily permeates.

### [First Modification]

In the second embodiment, the description has been made assuming that in the LUT used in reaction liquid amount decision processing, for each secondary color (a color obtained by mixing two or more color inks), an integrated value of reaction liquid amounts needed by the inks in the amounts is obtained as a reaction liquid amount. However, as the discharge amount of the reaction liquid for each secondary color, a value other than the integrated value of the reaction liquid amounts may be used.

For example, in a region where a plurality of color inks overlap, the necessary reaction liquid amount tends to be smaller than the sum of reaction liquid amounts needed when the color inks are imparted alone. Factors for this will be described below.

As the first factor, concerning the permeation speed of the reaction liquid alone, it is considered that when the reaction liquid contacts ink on the upstream side, the viscosity of the liquid in the mixture or the whole ink rises, and the permeation speed of the reaction liquid is reduced. This means that the reaction liquid remaining on the sheet at the timing of imparting ink on the downstream side increases as compared to a case where the reaction liquid is not in contact with the ink on the upstream side.

As the second factor, it is considered that when the reaction liquid contacts ink on the upstream side, the ink on the upstream side is fixed and exists like placed stones. This means that ink on the downstream side is difficult to flow in a planar direction, and as a result, the necessary reaction liquid amount decreases.

FIG. 14 is a view showing an example of the LUT used in reaction liquid amount decision processing according to the first modification. FIG. 14 shows a four-dimensional LUT corresponding to a sheet set as a sheet that a liquid readily permeates, and this is the same as the four-dimensional LUT shown in FIG. 9 except the lowermost row (secondary color). In the lowermost row of the LUT shown in FIG. 14, the P signal value to be output is “35” that is smaller than “44” that is the sum of the P signal value (here, 16) corresponding to the K signal value (here, 128) and the P signal value (here, 28) corresponding to the Y signal value (here, 128). When the discharge amount of the reaction liquid in the secondary color is set to a value larger than the integrated value of reaction liquid amounts needed by the inks in the amounts, image formation can be performed while suppressing image unevenness and ensuring high color developability.

The first modification assumes a configuration in which “reaction liquid”, “ink on the upstream side (in the conveyance direction)”, and “ink on the downstream side” are sequentially imparted to a sheet that a liquid readily permeates, as in the above-described example. As in the above-described example, when printing a primary color, a second amount of reaction liquid is imparted to a region where a first amount of ink on the upstream side is imparted, and a third amount (second amount<third amount) of the reaction liquid is imparted to a region where the first amount of ink on the downstream side is imparted.

In this modification, however, as described above, when printing a secondary color, a fourth amount of reaction liquid is imparted to the region where the first amount of ink on the upstream side is imparted, and the first amount of ink on the downstream side is imparted. Here, the fourth amount is decided such that it is equal to or smaller than the sum of the second amount and the third amount. When the discharge amount of the reaction liquid is decided using the LUT as described above, image formation can be performed while suppressing image unevenness and ensuring high color developability, as compared to a case where the LUT shown in FIG. 9 is used.

### [Second Modification]

In the first modification, a configuration that uses only one LUT to decide the discharge amount of the reaction liquid (assuming that, for example, use of a specific print medium) has been described. However, assuming a case where a plurality of print media are selectively used, the image forming apparatus 100 may selectively look up a plurality of LUTs corresponding to a plurality of print media when deciding the reaction liquid amount. In particular, when LUTs corresponding to those print media are prepared in accordance with the permeation easiness (permeation speed) of a liquid in each print medium, setting according to the type of each print medium can be done.

FIG. 15 is a view showing an example of a four-dimensional LUT corresponding to a sheet that a liquid hardly permeates, which is looked up in reaction liquid amount decision processing according to this modification. Here, as the sheet that a liquid hardly permeates, “PETWH50(A) PAT1 9K” is used as an example. In this sheet, the permeation speed of a test solution having a surface tension of 35 mN/m and a viscosity of 2 mPa·s was less than 0.5 μm/s².

The second modification assumes a configuration in which the reaction liquid, ink on the upstream side, and ink on the downstream side are sequentially imparted to the sheet, as in the above-described example. Here, for the sheet S that a liquid hardly permeates, if the second amount of reaction liquid is imparted to the region where the first amount of ink on the upstream side is imparted, the second amount of reaction liquid is imparted even to the region where the first amount of ink on the downstream side is imparted (that is, the discharge amount of the reaction liquid does not depend on upstream/downstream). Note that here, as the reaction liquid amount to be discharged when printing a secondary color on the sheet S that a liquid hardly permeates, an integrated amount of reaction liquid amounts for the amounts of inks of primary colors that form the secondary color is used. For example, to the region where the first amount of ink on the upstream side is imparted and the first amount of ink on the downstream side is imparted, a third amount of reaction liquid (here, third amount=second amount+second amount) is imparted. On the sheet that a liquid hardly permeates, the amount of the reaction liquid decreased from the sheet surface until the ink of each color is imparted after the reaction liquid is imparted may be neglected. For this reason, if the relationship of reaction liquid amounts as shown in FIG. 15 is set, image formation can be performed while suppressing image unevenness even on the sheet that a liquid hardly permeates.

### Third Embodiment

In the first and second embodiments, the reaction liquid amount for each ink is decided focusing the remaining amount of the reaction liquid on the print medium at the time of ink landing, thereby performing image formation while suppressing image unevenness. On the other hand, it can be considered that the discharge amount of the reaction liquid may be decided in consideration of the aggregability difference between ink and the reaction liquid. From this viewpoint, an image forming apparatus 100 according to the third embodiment sets the weight coefficient used in the first embodiment based on the aggregability difference between ink and the reaction liquid.

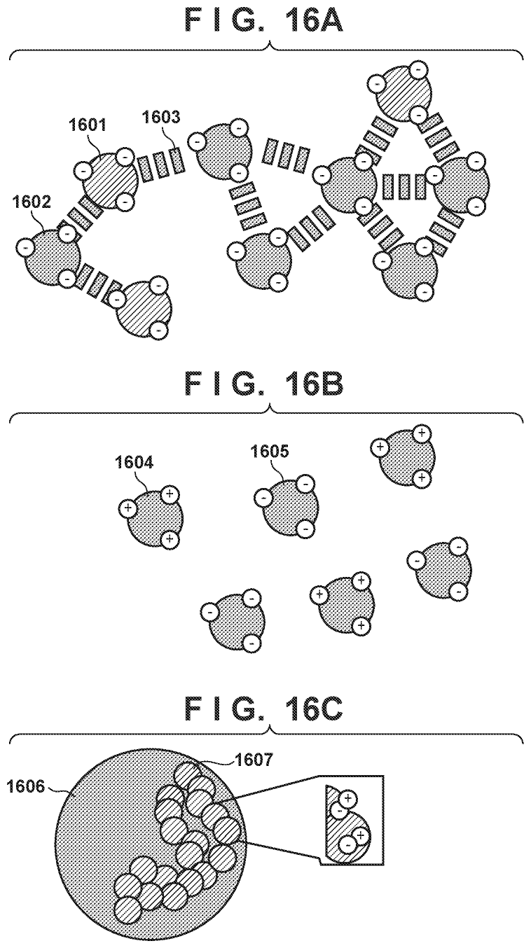

FIGS. 16A to 16C are views for explaining aggregation caused by the reaction between a reaction liquid and a color ink. A color material 1601 shown in FIG. 16A indicates the color material of a color ink, and a water-soluble resin 1602 is dispersed in the ink together with the color material 1601. In the example shown in FIG. 16A, both the color material and the water-soluble resin are dispersed as anions in water and stabilized by the repulsive force of negative charges. Simultaneously, a repulsive force 1603 (steric hindrance) in a physical structure also contributes to the dispersion. On the other hand, FIG. 16B shows the dispersion state of the reaction liquid. In this embodiment, the reaction liquid is ionized to magnesium ions 1604 in a positively charged cation state and sulfate ions 1605 in a negatively charged anion state and dispersed in water.

If the color ink and the reaction liquid are mixed, the anions in the color ink and the cations in the reaction liquid react with each other, and the charges are lost. Thus, the dispersion of the color material 1601 and the water-soluble resin 1602 is broken, and reaction aggregation occurs in the solvent. The higher the cation concentration in the reaction liquid is, the higher the cohesive force of the reaction liquid is. The higher the anion concentration of the color ink is, the higher the aggregation viscosity at the time of reaction aggregation tends to be.

The existence of a small quantity of cations in the reaction liquid does not necessarily cause reaction aggregation with the color ink, and a cation concentration to such an extent that breaks the steric hindrance 1603 is needed. FIG. 16C shows reaction aggregation that occurs as the result of mixing of the color ink and the reaction liquid, and an aggregate 1607 exists in a nonaggregate substance 1606. The aggregate 1607 contains the color material 1601 and the water-soluble resin 1602, which have caused the reaction aggregation, and the nonaggregate substance 1606 contains a liquid component such as water or a solvent.

In this embodiment, color inks having components shown in Table 2 below are used.

TABLE 2
Ink Compositions

| | Black Ink | Cyan Ink | Magenta Ink | Yellow Ink |
|---|---|---|---|---|
| Pigment | 35.0 | | | |
| Dispersion 1 | | | | |
| Pigment | | 35.0 | | |
| Dispersion 2 | | | | |
| Pigment | | | 35.0 | |
| Dispersion 3 | | | | |
| Pigment | | | | 35.0 |
| Dispersion 4 | | | | |
| Aqueous | 36.0 | 36.0 | 24.0 | 24.0 |
| Dispersion of | | | | |
| Resin Particles | | | | |
| 1,2-Propanediol | 15.0 | 15.0 | 15.0 | 15.0 |
| Acetylenol E100 | 0.5 | 0.5 | 0.5 | 0.5 |
| Pure Water | 13.5 | 13.5 | 13.5 | 13.5 |

In the inks of the components shown in Table 2, the mixing amount of the aqueous dispersion of resin particles in the black ink and the cyan ink increases, as compared to the inks shown in Table 1. The black ink and the cyan ink have dark colors as compared to the magenta ink and the yellow ink. Hence, when the resin amount in these inks is increased, the visibility of flaws can be lowered, and scratch resistance can be improved.

As for the component that causes reaction aggregation with the reaction liquid, not only the color material but also the water-soluble resin is known to make contribution. Hence, for example, if the inks have the same aggregability with the reaction liquid in the compositions shown in Table 1, the aggregability of the inks can be made different by increasing the resin amount. In this case, the weight coefficient is set in consideration of the aggregability difference between the ink and the reaction liquid, thereby suppressing generation of an insufficient color.

Reaction liquid amount decision processing performed by the image forming apparatus 100 according to this embodiment in consideration of the aggregability between the reaction liquid and a color ink (by setting a weight coefficient) will be described below.

### [Effects]

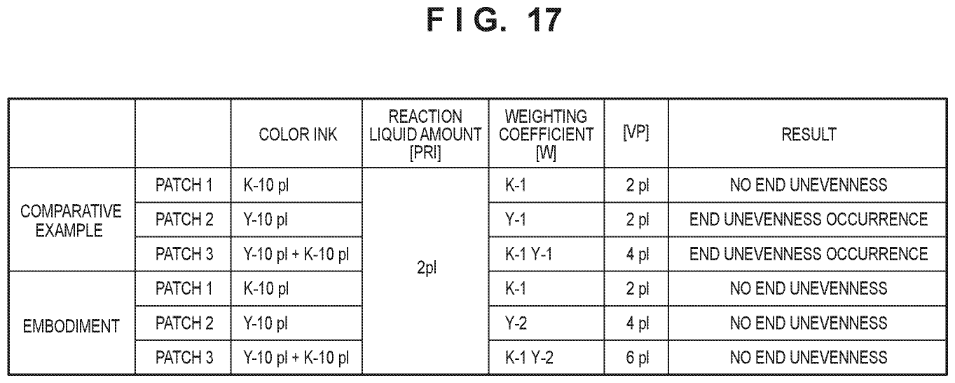

The aggregability difference between ink and the reaction liquid is more conspicuous on a sheet that absorbs the reaction liquid (or ink) slowly (or has no absorbency). In this embodiment, as an example, “PETWH50(A) PAT1 9K” was used as the sheet. FIG. 17 is a view for explaining, using a comparative example, effects obtained when processing by the image forming apparatus 100 according to this embodiment is performed. FIG. 17 shows, for patches 1 to 3, effects (comparative example) in a case where the reaction liquid amount is not changed in accordance with the type of ink and effects (this embodiment) in a case where the reaction liquid amount is decided by the image forming apparatus 100 according to this embodiment. The image forming apparatus 100 according to this embodiment decides a reaction liquid amount VP to be imparted for each patch using equation (6) below. In the first embodiment, the necessary reaction liquid amount is equal with respect to the ink amounts. In this embodiment, the necessary reaction liquid amount is different with respect to the ink amounts, and PRI in FIG. 17 indicates the reaction liquid amount. Since the print medium used in this embodiment absorbs slowly, the necessary reaction liquid amount can be small as compared to a sheet that absorbs quickly. In this embodiment, the reaction liquid amount necessary for 10 pl of black ink is defined, and is more specifically 2 pl. Note that here “absorb slowly” indicates that the time required for the reaction liquid (or ink) to be absorbed into the print medium is equal to or less than a predetermined time, and the predetermined time can arbitrarily be set.

$$VP = {\sum }_{n = 1}^{CN} PRI \times W ( {COL}_{n} ) \qquad ( 6 )$$

In the comparative example shown in FIG. 17, a weight coefficient W is set to 1 independently of ink. Also, in the comparative example, in patches 2 and 3 using yellow ink with low aggregability, end unevenness occurs as the result of the short aggregability. On the other hand, the image forming apparatus 100 according to this embodiment changes the weight coefficient W of the yellow ink with low aggregability to 2, and it is confirmed that end unevenness in patches 2 and 3 is eliminated, and there is no end unevenness.

Note that in this embodiment, a case where the aggregability difference between a color ink and the reaction liquid is determined by a resin amount contained in the ink has been described. In fact, however, it is considered that the aggregability of a color ink is determined by combined effects of the type and amount of each color material, the type and amount of the resin, and the solvent. When deciding the weight coefficient, the aggregability difference is examined and decided in advance, thereby deciding more correct weight coefficient. The aggregability can be decided based on the superiority/inferiority of uniformity of patches when, for example, the patches of the color inks are printed while setting the mixture ratios of the color inks and the reaction liquid to the same ratio. If ink has high aggregability, the patch can evenly be fixed by a small reaction liquid amount. If ink has insufficient aggregability, a phenomenon such as so-called end unevenness that unevenness occurs on an end side of the patch or beading that dots are locally aggregated occurs because aggregation is insufficient.

### Fourth Embodiment

In the above-described third embodiment, a reaction liquid amount decision method in a case where the amount of one color ink is 10 pl has been described, and the ratio between ink and the reaction liquid is constant regardless of the ink imparting amount. For this reason, the difference of aggregability of ink is considered based on only the weight coefficient. However, the aggregabilities of the color inks and the reaction liquid may change depending on the discharge amounts of the color inks. In order to adjust the reaction liquid amount in consideration of the discharge amount and aggregability, an image forming apparatus 100 according to this embodiment decides the reaction liquid amount to be discharged using two or more tables that define a reaction liquid amount for the discharge amount of each ink, which corresponds to a type of ink.

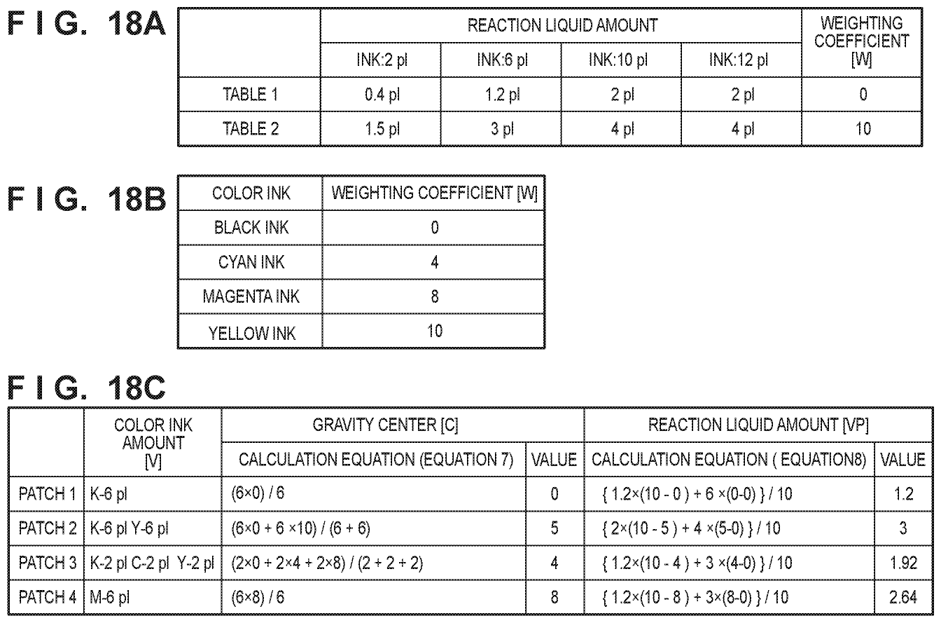

FIGS. 18A to 18C show a table that defines a reaction liquid amount corresponding to the discharge amount of each color ink and a calculation process of deciding the reaction liquid amount using the table. A reaction liquid amount PRI can be calculated by an LUT in accordance with the discharge amount of ink, as described above in the second embodiment. FIG. 18A shows reaction liquid amounts corresponding to 2 pl, 6 pl, 10 pl, and 12 pl in each table.

In this embodiment, two types of tables, that is, table 1 and table 2 are prepared. Table 1 is a table defined based on the examination result of black ink with high aggregability, and the ratio of the ink and the reaction liquid is constant here. Table 2 is a table defined based on the examination result of yellow ink with low aggregability, and the ratio of the ink and the reaction liquid is not constant here. Here, the reaction liquid discharge amounts for the black and yellow inks alone can be decided only by looking up the tables, and calculation using a weight coefficient need not be performed. On the other hand, for a mixed color patch (a multi color patch) using both the black ink and the yellow ink or a single color patch of cyan ink, the reaction liquid discharge amount cannot be decided only by looking up the lookup tables. Equation (7) is an equation used by the image forming apparatus 100 according to this embodiment to calculate a gravity center C for calculating the reaction liquid amount in the multi color patch.

$$VP = \frac{{\sum }_{n = 1}^{CN} V ( {COL}_{n} ) \times W ( {COL}_{n} )}{{\sum }_{n = 1}^{CN} V ( {COL}_{n} )} \qquad ( 7 )$$

In this embodiment, a weight coefficient W is set for each ink color in accordance with aggregability, and the values are shown in FIG. 18B. Here, the weight coefficient is set to 0 when the black ink is used, 4 when cyan ink is used, 8 when magenta ink is used, and 10 when the yellow ink is used.

Equation (8) is an equation used to calculate the reaction liquid amount PV and uses the gravity center C and the weight coefficient W. Reaction liquid amounts PRI1 and PRI2 are reaction liquid amounts obtained from table 1 and table 2, respectively, and weight coefficients W1 and W2 are weight coefficients in table 1 and table 2.

$$VP = \frac{PRI 1 \times ( W 2 - C ) + PRI 2 \times ( C - W 1 )}{W 1 + W 2} \qquad ( 8 )$$

FIG. 18C shows, for each of patches 1 to 4, the type and amount of a color ink to be imparted and equations concerning the gravity center and the reaction liquid amount. Here, as indicated by equations shown in FIG. 18C, each of PRI1 and PRI2 is a reaction liquid amount calculated not from the discharge amount of ink alone but from the total amount of inks imparted to the patches. In addition, the gravity center C means the distance from the reaction liquid amount PRI1 of ink with high aggregability and the reaction liquid amount PRI2 of ink with high aggregability. That is, for the combination of inks with high aggregability, the gravity center value is close to 0 (that is, small).

As described above with reference to FIGS. 18A to 18C, by using the plurality of tables and the gravity center calculated from the weight coefficient decided in consideration of aggregability, a more appropriate reaction liquid amount can be set for each ink color. If the tables indicating the reaction liquid amounts for the ink amounts to be used are held in the image forming apparatus main body, the image forming apparatus main body needs a capacity, and the processing time becomes long because many tables are looked up when deciding the reaction liquid amount. On the other hand, according to the processing of this embodiment, the reaction liquid amount can be calculated by a simple expression (here, a linear expression) using the reaction liquid amount and the weight coefficient. It is therefore possible to decide an appropriate reaction liquid amount according to aggregability while suppressing the processing time.

Note that the influence of the aggregability difference between the reaction liquid and ink is more conspicuous on paper that has absorbency (or absorbs slowly). However, the influence also exists on paper that has absorbency (or absorbs quickly). On paper having absorbency, as described in the modification of the second embodiment, a weight coefficient considering both aggregability and a decrease amount according to time is used in consideration of the influence of a liquid amount absorbed in the paper, thereby further optimizing the reaction liquid amount.

The lower the aggregability is, the more the reaction liquid amount is needed. However, the use amount of the reaction liquid is preferably small, considering reduction of cost necessary for printing. From this viewpoint, as for the color order of inks to be discharged, the inks are arranged in ascending order of aggregability sequentially from the side close to the reaction liquid, thereby decreasing the necessary reaction liquid amount.

### Fifth Embodiment

The image forming apparatus 100 according to each of the first to fourth embodiments has been described as a full line type image forming apparatus. An image forming apparatus 1900 according to this embodiment is a serial type image forming apparatus that performs image formation while moving the nozzle arrays of the printing unit in a direction orthogonal to the conveyance direction of a print medium along with the conveyance of a print medium. The image forming apparatus 1900 according to the fifth embodiment has the same configuration as the first to fourth embodiments except a configuration to be described below and can execute the same processing, and a repetitive description thereof will be omitted.

### [Image Forming Apparatus and Printing Unit]

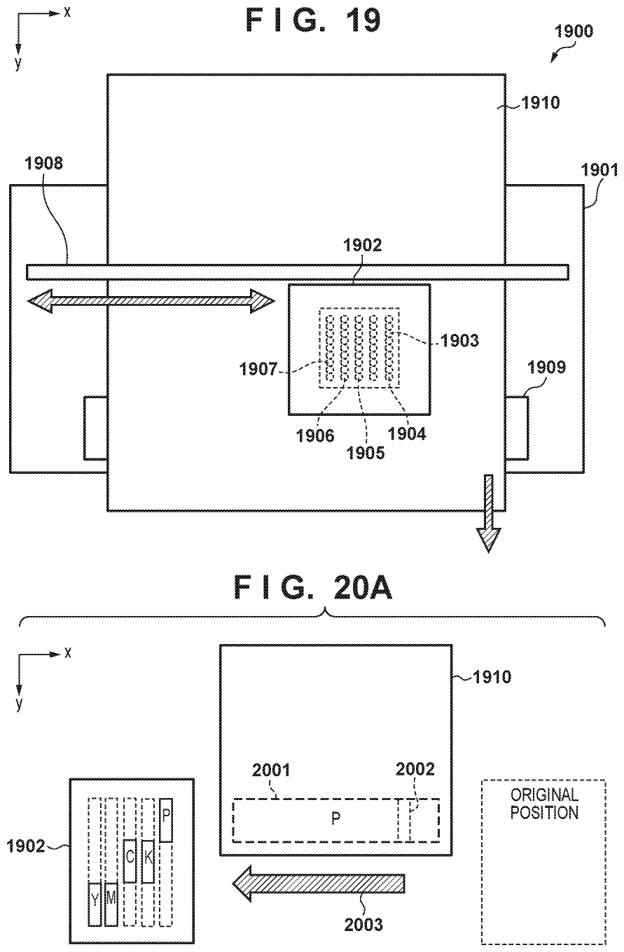

FIG. 19 is a view schematically showing the serial type image forming apparatus according to this embodiment. As shown in FIG. 19, the image forming apparatus 1900 includes a printing unit 1902 on a frame that forms the structural material of the image forming apparatus. On the printing unit 1902, a plurality of printheads configured to discharge inks are mounted. The printheads include a black (K) printhead 1904, a cyan (C) printhead 1905, a magenta (M) printhead 1906, and a yellow (Y) printhead 1907.

In the image forming apparatus 1900 shown in FIG. 19, nozzles are arrayed in a direction (x direction) orthogonal to the conveyance direction (widthwise direction) of a print medium 1910, and the printing unit 1902 is operated along a guide 1908, thereby performing image formation while moving the nozzle arrays relative to the print medium 1910. The resolution of the nozzle arrangement of the nozzle arrays of ink colors is 1,200 dpi.

The print medium 1910 is conveyed in the y direction in FIG. 19 when a conveyance roller 1909 (and other rollers (not shown)) is rotated by a motor (not shown). After the print medium 1910 is fed, inks are discharged, in accordance with formation data, from a plurality (predetermined number) of nozzles of the printing unit 1902, thereby forming an image of one scanning width corresponding to the nozzle array of the printing unit. After image formation, the print medium is conveyed again in the y direction in FIG. 19 by a width corresponding to the nozzle array, and an image of one scanning width is formed again. The conveyance of the print medium and the ink discharge operation from each printing unit to the print medium are repeated, thereby forming, for example, an image of one page.

In the serial type image forming apparatus, depending on dot landing accuracy in image formation, image quality may degrade due to color unevenness or streaks caused by position deviation. To avoid the image quality degradation, it is effective to perform image formation (multi-pass printing) by divisionally performing a plurality of times of scanning, instead of performing image formation (one-pass printing) by one scanning on the print medium.

### [Calculation of Reaction Liquid Amount]

Calculation processing of the discharge time difference between the reaction liquid and each ink in the serial type image forming apparatus, which is performed by the image forming apparatus 1900 according to this embodiment, will be described below. Reaction liquid amount calculation processing except this point can be performed in accordance with the same procedure as in the first embodiment.

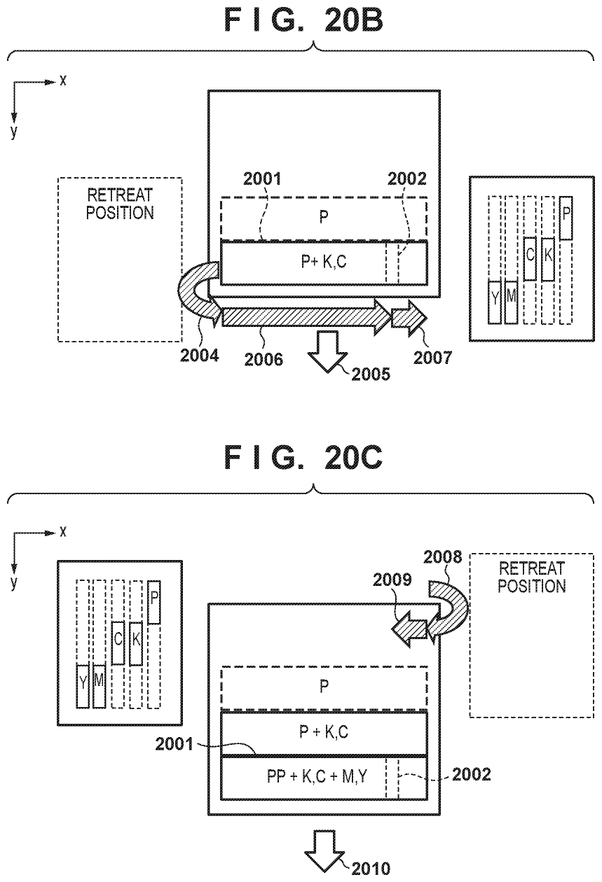

To make each ink land after the reaction liquid permeates on the print medium, the image forming apparatus 1900 performs image formation by dividing the use area of printing elements. FIGS. 20A to 20C are views for explaining the time difference generated between reaction liquid discharge and color ink discharge of each group by the operations of the printing unit 1902 and the print medium 1910 when image formation is performed by the serial type image forming apparatus. FIGS. 20A to 20C show examples of passes when the nozzles are divided, and bidirectional formation is performed by multi-pass printing. In the example shown in FIGS. 20A to 20C, according to the ejection order, the divided nozzle groups are three groups including a reaction liquid, color group 1 formed by K and C, and color group 2 formed by M and Y. As for the use positions of the divided nozzles, the reaction liquid is assigned to the upper stage, color group 1 is assigned to the middle stage, and color group 2 is assigned to the lower stage.

A factor that causes the time difference between reaction liquid discharge and color ink discharge of each group (this will sometimes simply be referred to as “time difference” hereinafter) will be described, in the order of A to C, concerning a position 2002 of interest in FIGS. 20A to 20C. First, in FIG. 20A, as image formation processing of the first pass, the reaction liquid at the upper stage of the divided nozzles is discharged. Next, while operating the printing unit 1902 in the x direction from the original position, the reaction liquid is discharged from nozzles assigned for the reaction liquid and ink, thereby forming an image in a formation region 2001.

For the position 2002 of interest, a time 2003 from the start of formation of the reaction liquid at the position 2002 of interest until the printing unit 1902 moves to the left end of the formation region 2001 is added to the time difference. Furthermore, a time 2004 until the printing unit 1902 turns back at the retreat position at the left end in FIG. 20B and returns to the left end of the formation region 2001 is added to the time difference. In addition to the movement of the printing unit, conveyance of the print medium is performed. The conveyance amount of the print medium equals the nozzle height of each group of divided nozzles. Here, the print medium is moved in the y direction by an amount as much as the image formation height of the reaction liquid in the y direction. Hence, a time 2005 required for the conveyance of the print medium is added to the time difference. Note that the conveyance of the print medium may be performed in parallel to the turnback/movement of the printing unit. In this case, a time needed for the conveyance and the turnback/movement is added to the time difference. In this embodiment, a case where the turnback/movement and the conveyance are not performed in parallel will be described as an example. After that, similarly in FIG. 20B, formation of color group 1 is performed from the left end to the right of the formation region 2001 along with the movement of the printing unit 1902, and a time 2006 required for the movement from the left end of the formation region 2001 to the position 2002 of interest is added to the time difference.

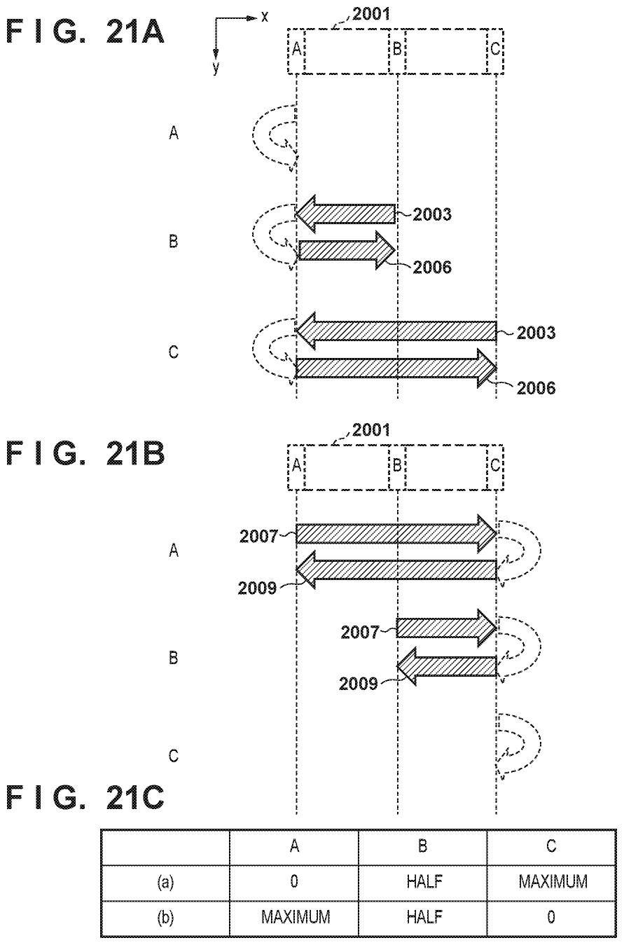

Here, the lengths of the time 2003 and the time 2006 are different depending on the position of the region of interest. FIGS. 21A to 21C show the difference of time generated for each position of the region of interest on the formation region 2001. In FIGS. 21A and 21B, A, B, and C are the left end position, the intermediate position, and the right end position of the formation region 2001. A table in FIG. 21C shows the times generated in FIGS. 21A and 21B from 0 to the maximum.

The time required on the formation region 2001 from reaction liquid discharge to discharge of color group 1 for each of the positions A, B, and C will be described below with reference to FIG. 21A. Since A is the left end position, time required from reaction liquid discharge to movement up to the left end of the formation region is not generated, and is 0. At the position B, time required for formation of the reaction liquid from the intermediate position to the left end and time required, after turnback, for formation of color group 1 from the left end to the position B are generated, and a half of time required for image formation in the entire formation region 2001 is added to the time difference. Since C is the right end position, the time required for formation in the entire formation region 2001 is directly added to the time difference.

Note that in this embodiment, the moving speed of the printing unit 1902 on the formation region 2001 is constant, and the time 2003 and the time 2006 have the same length. However, if the speed of the printing unit 1902 is not constant, the time 2003 and the time 2006 may have different lengths. From above, a time difference (T1) required from reaction liquid discharge to discharge of color group 1 can be obtained by

$$T 1 = {t}_{c} ( px ) \times 2 + {t}_{w} + {t}_{LF} \qquad ( 9 )$$

where t_{C}(px) is time required for the printing unit to move in one direction. The position of the region of interest on the formation region is designated by px. Also, t_{W} is time required for turnback of the printing unit.

In equation (9), t_{C}(px) represents time required for one of the time 2003 and the time 2006, and “×2” is performed in sense of adding these. Calculation of equation (9) is done for each position in the x direction on the formation region, and performed for every plurality of regions divided in the x direction. The time difference between discharge of the reaction liquid and discharge of color group 2 is obtained by further adding time to the time difference T1 between discharge of the reaction liquid and discharge of color group 1.

In FIG. 20C, printing of color group 2 is performed using the lower stage of the divided nozzles. First, the distance from the position 2002 of interest to the right end of the formation region 2001 at the time of formation of color group 1 in FIG. 20B is added as a time 2007 to the time difference. Next, a time 2008 required to turn back at the retreat position at the left end in FIG. 20C and return to the right end of the formation region 2001 is added to the time difference. Simultaneously, conveyance of the print medium is performed, and a time 2020 required for this is added to the time difference. After that, similarly in FIG. 20C, formation of color group 2 is performed from the right end to the left of the formation region 2001 along with the movement of the printing unit 1902, and a time 2009 required for the movement from the right end of the formation region 2001 to the position 2002 of interest is added to the time difference. The lengths of the time 2007 and the time 2009 are different depending on the position of the region of interest.

A time T2 required on the formation region 2001 from discharge of color group 1 to discharge of color group 2 for each of the positions A, B, and C will be described next with reference to FIG. 21B. Since A is the left end position, reversely to FIG. 21A, time required for formation in the entire formation region 2001 is directly added to the time difference. At the position B, time required for formation of color group 1 from the intermediate position to the right end and time required, after turnback, for formation of color group 2 from the right end to the position B are generated. Since C is the right end position, time required from reaction liquid discharge to movement up to the left end of the formation region is not generated, and is 0. From above, a time difference (T2) required from discharge of color group 1 to discharge of color group 2 can be obtained by

$$T 2 = T 1 + ( {t}_{max} - {t}_{c} ( px ) ) \times 2 + {t}_{w} + {t}_{LF} \qquad ( 10 )$$

where tₘₐₓ is time required for formation in the entire formation region. In equation (10), tₘₐₓ represents time required for formation in the entire formation region 2001, and tₘₐₓ−t_{C}(px) is maximum when px is the left end, and t_{C}(px) is 0.

Note that in this example, the time 2005 and the time 2020 required for conveyance have the same length, and the time 2004 and the time 2008 required for turnback of the printing unit 1902 have the same length. However, these may have different lengths and can be set to arbitrary values in accordance with settings or conditions.

With this processing, the time difference can be calculated for each of color group 1 and color group 2. Other calculation methods including calculation of a weight coefficient can be performed using the same expressions as in the first embodiment. In this embodiment, weight coefficient calculation is performed not for each ink but for each color group.

Note that in this embodiment, the discharge time difference derived from the difference between the x direction positions of print nozzles 1903 to 1907 for the reaction liquid and the color inks in the region of interest is sufficiently small and can therefore be neglected. However, it may be calculated in addition to equations (9) and (10).

According to this processing, even in the serial type image forming apparatus 1900, the time difference between discharge of the reaction liquid and discharge of each color ink can be calculated. Hence, the weight coefficient is set to compensate for the reaction liquid decrease amount, and the discharge amount of the reaction liquid can be decided such that the larger the reaction liquid decrease amount of a color group is, the larger the discharge amount is. Thus, as in the first embodiment, even if the reaction liquid amount decreases along with the elapse of time, it is possible to suppress shortage of the reaction liquid amount at the time of landing of ink, and appropriate reaction can be held.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-088068, filed May 29, 2023, Japanese Patent Application No. 2023-099544, filed Jun. 16, 2023, and Japanese Patent Application 2024-026908, filed Feb. 26, 2024 which are hereby incorporated by reference herein in their entirety.

What is claimed is:

1. An image forming apparatus comprising:
a deciding unit configured to decide a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and
a controlling unit configured to control discharge of the reaction liquid and the inks of the not less than two colors.

2. The apparatus according to claim 1, wherein the deciding unit decides the discharge amount of the reaction liquid based on a weight coefficient set based on the timing at which the reaction liquid is discharged onto the print medium, the timing at which each of the inks of the not less than two colors is discharged onto the print medium next to the reaction liquid, and the discharge amount of each of the inks of the not less than two colors by the image forming apparatus.

3. The apparatus according to claim 2, wherein the weight coefficient is set for each of inks included in the inks of the not less than two colors.

4. The apparatus according to claim 3, wherein a first weight coefficient set for a first ink included in the inks of the not less than two colors is set to be not more than a second weight coefficient set for a second ink included in the inks of the not less than two colors, and
a distance from a printing element that discharges the reaction liquid to a printing element that discharges the first ink is less than a distance from the printing element that discharges the reaction liquid to a printing element that discharges the second ink.

5. The apparatus according to claim 2, wherein the weight coefficient is set based on a distance from a printing element that discharges the reaction liquid to a printing element that discharges the ink.

6. The apparatus according to claim 2, wherein the weight coefficient is set based on a relative moving speed between the print medium and printheads that discharge the reaction liquid and the inks.

7. The apparatus according to claim 2, wherein the weight coefficient is set further based on a type of the print medium.

8. The apparatus according to claim 2, wherein the weight coefficient is set further based on a type of the ink.

9. The apparatus according to claim 1, wherein the deciding unit decides the discharge amount of the reaction liquid based on a table that stores the discharge amount of the reaction liquid corresponding to the timing at which the reaction liquid is discharged onto the print medium, the timing at which each of the inks of the not less than two colors is discharged onto the print medium next to the reaction liquid, and the discharge amount of each of the inks of the not less than two colors by the image forming apparatus.

10. The apparatus according to claim 9, wherein in addition to the timing at which the reaction liquid is discharged onto the print medium, the timing at which each of the inks of the not less than two colors is discharged onto the print medium next to the reaction liquid, and the discharge amount of each of the inks of the not less than two colors by the image forming apparatus, the table stores the discharge amount of the reaction liquid corresponding to a distance from a printing element that discharges the reaction liquid to a printing element that discharges the ink.

11. The apparatus according to claim 9, wherein in addition to the timing at which the reaction liquid is discharged onto the print medium, the timing at which each of the inks of the not less than two colors is discharged onto the print medium next to the reaction liquid, and the discharge amount of each of the inks of the not less than two colors by the image forming apparatus, the table stores the discharge amount of the reaction liquid corresponding to a type of the print medium.

12. The apparatus according to claim 9, wherein in addition to the timing at which the reaction liquid is discharged onto the print medium, the timing at which each of the inks of the not less than two colors is discharged onto the print medium next to the reaction liquid, and the discharge amount of each of the inks of the not less than two colors by the image forming apparatus, the table stores the discharge amount of the reaction liquid corresponding to a type of the ink.

13. The apparatus according to claim 1, wherein the controlling unit controls discharge of the reaction liquid and the inks of the not less than two colors by a full line type printhead having a width not less than a width of the print medium.

14. The apparatus according to claim 1, wherein the controlling unit controls discharge of the reaction liquid and the inks of the not less than two colors while moving a nozzle array of a serial type printhead in a direction orthogonal to a conveyance direction of the print medium along with conveyance of the print medium.

15. An image forming apparatus comprising:
a controlling unit configured to control discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged;
a classifying unit configured to classify the print medium into a print medium that a liquid readily permeates and a print medium that a liquid hardly permeates; and
a setting unit configured to set a discharge amount of the reaction liquid corresponding to a discharge amount of one of the first ink and the second ink,
wherein the setting unit sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

16. The apparatus according to claim 15, wherein the setting unit sets, for the print medium that the liquid readily permeates, a fifth discharge amount of the reaction liquid to be discharged to a region on the print medium where the first discharge amount of the first ink is discharged and a fourth discharge amount of the second ink is discharged to a discharge amount smaller than a sum of the first discharge amount and a sixth discharge amount of the reaction liquid corresponding to the fourth discharge amount of the second ink.

17. The apparatus according to claim 15, wherein the setting unit sets, for the print medium that the liquid hardly permeates, a discharge amount of the reaction liquid such that the second discharge amount and the third discharge amount equal.

18. The apparatus according to claim 15, wherein the setting unit sets, for the print medium that the liquid hardly permeates, a fifth discharge amount of the reaction liquid to be discharged to a region on the print medium where the first discharge amount of the first ink is discharged and a fourth discharge amount of the second ink is discharged to a sum of the first discharge amount and a sixth discharge amount of the reaction liquid corresponding to the fourth discharge amount of the second ink.

19. The apparatus according to claim 15, wherein the image forming apparatus is an inkjet image forming apparatus.

20. An image forming apparatus comprising:
a setting unit configured to set a weight coefficient on an ink type basis for each of a reaction liquid discharged onto a print medium by the image forming apparatus and an ink discharged onto the print medium next to the reaction liquid; and
a deciding unit configured to decide, based on the weight coefficient and a discharge amount of the ink by the image forming apparatus, a discharge amount of the reaction liquid discharged before the ink.

21. The apparatus according to claim 20, wherein the setting unit sets the weight coefficient based on aggregability of the ink.

22. The apparatus according to claim 20, wherein the setting unit sets the discharge amount of the reaction liquid using at least two tables that define the discharge amount of the reaction liquid corresponding to the discharge amount of the ink.

23. The apparatus according to claim 20, wherein the setting unit sets the weight coefficient for each print medium.

24. The apparatus according to claim 20, wherein the ink is discharged, next to the reaction liquid, sequentially from a type having low aggregability.

25. An information processing method comprising:
deciding a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and
controlling discharge of the reaction liquid and the inks of the not less than two colors.

26. An information processing method comprising:
controlling discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged;
classifying the print medium into a print medium that a liquid readily permeates and a print medium that a liquid hardly permeates; and
setting a discharge amount of the reaction liquid corresponding to a discharge amount of one of the first ink and the second ink,
wherein the setting sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

27. An information processing method comprising:
setting a weight coefficient on an ink type basis for each of a reaction liquid discharged onto a print medium by the image forming apparatus and an ink discharged onto the print medium next to the reaction liquid; and
deciding, based on the weight coefficient and a discharge amount of the ink by the image forming apparatus, a discharge amount of the reaction liquid discharged before the ink.

28. A non-transitory computer-readable storage medium storing a program that, when executed by a computer, causes the computer to perform an information processing method, the information processing method comprising:
deciding a discharge amount of a reaction liquid based on a timing at which the reaction liquid is discharged onto a print medium by the image forming apparatus, a timing at which each of inks of not less than two colors is discharged onto the print medium next to the reaction liquid, and a discharge amount of each of the inks of the not less than two colors by the image forming apparatus; and
controlling discharge of the reaction liquid and the inks of the not less than two colors.

29. A non-transitory computer-readable storage medium storing a program that, when executed by a computer, causes the computer to perform an information processing method, the information processing method comprising:
controlling discharge of a reaction liquid, a first ink, and a second ink by the image forming apparatus such that the reaction liquid is discharged to a print medium by one pass, and the first ink is discharged to at least a part of a region where the reaction liquid is discharged and the second ink is discharged to at least a part of the region where the reaction liquid is discharged;
classifying the print medium into a print medium that a liquid readily permeates and a print medium that a liquid hardly permeates; and
setting a discharge amount of the reaction liquid corresponding to a discharge amount of one of the first ink and the second ink,
wherein the setting sets, for the print medium that the liquid readily permeates, a second discharge amount of the reaction liquid corresponding to a first discharge amount of the first ink such that the second discharge amount is smaller than a third discharge amount of the reaction liquid corresponding to the first discharge amount of the second ink.

30. A non-transitory computer-readable storage medium storing a program that, when executed by a computer, causes the computer to perform an information processing method, the information processing method comprising:
setting a weight coefficient on an ink type basis for each of a reaction liquid discharged onto a print medium by the image forming apparatus and an ink discharged onto the print medium next to the reaction liquid; and
deciding, based on the weight coefficient and a discharge amount of the ink by the image forming apparatus, a discharge amount of the reaction liquid discharged before the ink.
